(19) United States
(12) Patent Application Publication
(10) Pub. No.: US 2025/0265851 A1
(43) Pub. Date: Aug. 21, 2025

(54) APPARATUSES, SYSTEMS, AND METHODS FOR PROCESSING OF THREE DIMENSIONAL OPTICAL MICROSCOPY IMAGE DATA

(71) Applicant: Alpenglow Biosciences, Inc., Seattle, WA (US)

(72) Inventors: Synclair CHENDRANAGA, Seattle, WA (US); Nathan C. GRANT, Seattle, WA (US); Nicholas P. REDER, Seattle, WA (US); Caleb R. STOLTZFUS, Seattle, WA (US); David A. SIMMONS, Seattle, WA (US); Jasmine J. WILSON, Seattle, WA (US)

(21) Appl. No.: 19/177,229

(22) Filed: Apr. 11, 2025

Related U.S. Application Data
(63) Continuation of application No. PCT/US2023/076740, filed on Oct. 12, 2023.
(60) Provisional application No. 63/416,267, filed on Oct. 14, 2022.

(51) Int. Cl. G06V 20/69; G02B 21/36; G06V 10/25; G06V 10/26; G06V 10/764; G06V 20/64

(52) U.S. Cl. CPC G06V 20/695; G02B 21/365; G06V 10/25; G06V 10/26; G06V 10/764; G06V 20/64; G06V 20/693; G06V 20/698; G06V 2201/03

(57) ABSTRACT

Systems and methods for capturing and processing image data captured by an optical microscope, such as an Open Top Light Sheet (OTLS) microscope are disclosed. Image data can be processed by techniques including flat fielding, image depth correction, and edge correction, and pixel classification and image segmentation techniques can be applied to more accurately identify lipid droplets and fibrous structures for assessment of, for example, steatosis and fibrosis in human liver biopsy tissue samples. Systems and methods are also related to capturing low resolution images of a sample, identifying regions of interest, and then capturing high resolution image of the regions of interest to reduce memory used for storage, increase computation speed, and reduce computational power.

### CROSS REFERENCE TO RELATED APPLICATIONS

This application is a continuation of International Application No. PCT/US2023/076740, filed Oct. 12, 2023, which claims priority to and the benefit of U.S. Provisional Application No. 63/416,267, filed Oct. 14, 2022, and entitled “Apparatuses, Systems, and Methods for Processing of Three Dimensional Optical Microcopy Image Data,” the entire disclosures of which are hereby incorporated herein by reference.

This application is also related to U.S. Patent No. 11,644,656, issued May 9, 2023, entitled “Open-Top Light-Sheet Microscopy with Non-Orthogonal Arrangement of Illumination and Collection Objectives” (the '656 patent), U.S. Patent Application Publication No. 2022/0050280, filed Jul. 27, 2021, entitled “Apparatuses, Systems and Methods for Microscope Sample Holders,” (the '280 application), and PCT Publication No. WO 2022/155096, filed Jan. 10, 2022, entitled “Apparatuses, Systems, and Methods for Generating Synthetic Image Sets,” (the '096 application), the entire disclosure of each of which is incorporated herein by reference.

### STATEMENT REGARDING RESEARCH AND DEVELOPMENT

One or more embodiments disclosed herein were made with government support under Grant Number: 1 R43 DK130751-01 awarded by the National Institutes of Health. The government has certain rights in the invention.

### BACKGROUND

Three-dimensional (3D) microscopy of tissue specimens or samples can yield large amounts of high-resolution micro-scale structural information, which can lead to important biological discoveries or used for clinical assays. Open Top Light Sheet (OTLS) optical microscopes can be particularly effective tools for acquiring 3D image data from tissue samples. As shown in FIG. 1, an OTLS microscope can have a source (e.g., a laser, an ultraviolet light source, an infrared light source, etc.) that generates illumination light and illumination optics which direct the illumination light onto a tissue sample disposed on a sample holder, and collection optics that can receive light from the sample and direct the received light onto a detector (such as a complementary metal-oxide semiconductor (CMOS) camera). As shown in FIG. 1, a principle optical axis of the illumination path of the illumination light may be at an angle (e.g., orthogonal to) the principle optical axis of the collection path of the collection optics. The illumination light may be focused to a light sheet (e.g., focused such that it is much wider than it is thick). The microscope may be used to generate a depth stack (or z-stack) of images, such as shown in FIG. 2. For example, an actuator may position the sample such that a first image is taken with the image being generally in an x-y plane. The actuator may then move the sample a set distance along an axis orthogonal to the imaging plane (e.g., along the z-axis), and a second image may be captured. This may be repeated a number of times to build up a set of 2D images which represent a 3D volume of the sample.

The raw image data acquired may include undesired artifacts that arise from the nature of the OTLS system and its optics. For example, the acquired signal intensity may be reduced, or drop off, as a function of depth into the tissue sample, because of the attenuation of the illumination laser in the tissue. The illumination laser intensity can also vary across the field of view of the detector (e.g., camera), which can lead to signal intensity drop off at the edges of the individual 2D images—when the full 3D data are generated by stitching together the 2D images, dim “lines” can be created in the 3D data set. Another undesirable effect can be produced when the tissue is stained with a contrast agent that includes an antibody (bound to a fluorophore), the edges of the tissue sample can accumulate excess antibody, which leads to non-specific staining.

For both biological studies and clinical assays, a first step in analyzing large 3D microscopy datasets is often to first extract (or segment) out key tissue structures so that those structures can be quantified. For example, it may be necessary to segment out specific cell types such as immune cells to quantify their spatial distributions and relationships with other cell types such as tumor cells. Likewise, it may be helpful to segment out tissue structures such as vessels or glands in order to extract quantitative “features” (geometric parameters) that can be predictive of disease aggressiveness (i.e., prognosis) or predictive of response to specific forms of therapy. Some types of tissue and some pathologies may be particularly difficult to analyze and interpret. For example, liver fibrosis is the hallmark feature of all chronic liver diseases. Histopathological examination of liver biopsy is considered the “gold standard” for the assessment of liver fibrosis. It is desirable to be able to image an entire liver biopsy sample and evaluate the severity of liver damage based on the quantity and spatial distribution of fibrosis and steatosis. However, the traditional method, based on 2D image data, is subject to significant under sampling and interpretative errors. This is shown in FIG. 3, in which a long tubular structure (which may be any long tubular feature, such as a blood vessel, fiber, duct, chemokine gradient, etc.) is shown in a 2D image plane through a 3D structure.

Accordingly, a need exists for imaging processing techniques for 3D image data, such as acquired by an OTLS microscope, that can address the image artifacts noted above and to improve image analysis for tissue samples such as liver biopsies.

### SUMMARY

Embodiments described herein relate to apparatuses, systems, and methods for processing optical microscopy imaging data. In some aspects, an apparatus includes a processor capable of being communicatively coupled to an imaging device that is configured to image a sample; and a memory operatively coupled to the processor, the memory storing executable instructions that, when executed by the processor, cause the processor to execute operations including: receive a low resolution image of the sample; perform a first image processing operation on the low resolution image to determine regions of interest (ROIs) of the sample within the low resolution image; select one or more of the determined ROIs for high resolution imaging based on the determination or an input from a user; receive high resolution images of the selected ROIs of the sample from the imaging device; perform a second image processing operation on the high resolution images to generate processed high resolution images; and generate a signal indicative of the processed high resolution images. In some embodiments, the processor includes a set of processors operatively coupled to each other in parallel, the first image processing operation includes applying bricking to the low resolution image to generate a first bricked image dataset, and the second image processing operation includes applying bricking to the high resolution images to generate a second bricked image dataset. In some embodiments, at least one of the first bricked image dataset or the second bricked image dataset is processed in parallel to determine the regions of interest or the second bricked image is processed in parallel to generate the processed high resolution images.

In some aspects, a system includes an imaging device configured to capture images of a sample; a computing system communicatively coupled to the imaging device, the computing system including: a processor communicatively coupled to the imaging device; a memory operatively coupled to the processor, the memory storing executable instructions that, when executed by the processor, cause the processor to execute operations including: transmit a first signal to the imaging device, the first signal configured to cause the imaging device to capture a low resolution image of the sample; receive the low resolution image from the imaging device; process the low resolution image to determine regions of interest (ROIs) of the sample within the low resolution image; select one or more of the determined ROIs for high resolution imaging based on the determination or an input from a user; transmit a second signal to the imaging device, the second signal configured to cause the imaging device to capture high resolution images of the selected ROIs; receive the high resolution images from the imaging device; process the high resolution images to generate processed high resolution images; and generate a signal indicative of the processed high resolution images. In some embodiments, the imaging device includes a low resolution objective and a high resolution objective, and causing the imaging device to capture the low resolution image includes causing the imaging device to use the low resolution objective to capture the low resolution image of the sample, and causing the imaging device to capture the high resolution images includes causing the imaging device to use the high resolution objective to capture the high resolution image of the ROIs. In some embodiments, the imaging device includes an actuator, the first signal is configured to cause the actuator to move the low resolution objective to a first predetermined position for imaging the sample, and the second signal is configured to cause the actuator to move the high resolution objective to a second predetermined position imaging the ROIs. In some embodiments, the second signal is also configured to move at least one of the high resolution objective or the sample to enable the high resolution objective to capture the high resolution images of the selected ROIs. In some embodiments, the imaging device includes a detector configured to capture optical signals received from the sample, and capturing the low resolution image includes down sampling of optical signals received from the sample. In some embodiments, the processor includes a set of processors operatively coupled to each other in parallel, the first image processing operation includes applying bricking to the low resolution image to generate a first bricked image dataset, and the second image processing operation includes applying bricking to the high resolution images to generate a second bricked image dataset.

In some aspects, an apparatus includes a processor capable of being communicatively coupled to an imaging device that is configured to image a sample; and a memory operatively coupled to the processor, the memory storing executable instructions that, when executed by the processor, cause the processor to execute operations including: receive a set of images of the sample captured by the imaging device; perform a set of image processing operations on the set of images to obtain optimized image data; classify pixels in the optimized image data into one or more classes; segment the optimized image data based on features of interest; quantify the optimized image data; correlate the optimized image data to quantify structures in the optimized image data corresponding to a medical indication; and generate a signal indicative of the medical indication.

### BRIEF DESCRIPTION OF THE DRAWINGS

FIG. 1 is an illustration of an OTLS microscope and tissue sample.

FIG. 2 is an illustration of a stack of 2D images that can be acquired by a microscope such as the OTLS shown in FIG. 1.

FIG. 3 is an illustration of a 3D tissue structure and an image in a 2D plane.

FIG. 4A is a schematic block diagram of a system including an imaging device and a computing system communicatively coupled to the imaging device, according to an embodiment. FIG. 4B is a schematic block diagram of the system of FIG. 4A illustrating components included in the imaging device and computing system of the system, according to an embodiment.

FIG. 5A is a flow chart of a method of preparing, imaging, and processing image data for, a tissue sample, according to an embodiment.

FIG. 5B is a flow chart of a method of capturing and processing image data from a sample, according to an embodiment.

FIG. 5C to 5F are images illustrating ROI selection of a biological tissue, according to an embodiment.

FIGS. 6A to 6D are images illustrating flat field correction, according to an embodiment.

FIGS. 7A to 7D are images illustrating depth correction, according to an embodiment.

FIGS. 8A to 8G are images illustrating various steps of edge correction, according to an embodiment.

FIGS. 9A to 9C are example image data for a tissue sample from a liver biopsy, acquired from an OTLS microscope such as shown in FIG. 1.

FIGS. 10A and 10B are example 3D and 2D computational channels for steatosis.

FIGS. 11A and 11B are example 3D and 2D computational channels for fibrosis.

FIGS. 12A and 12B are 3D and 2D meshes of steatosis based on the computational channels of FIGS. 10A and 10B.

FIGS. 13A and 13B are 3D and 2D meshes of fibrosis based on the computational channels of FIGS. 11A and 11B.

FIG. 14 illustrates the distribution of surface areas of lipid droplets in the tissue sample, calculated from the meshes of FIGS. 12A and 12B.

FIG. 15A shows the percentage of fibrosis as a function of position in the image slice of the tissue based on the computational channels such as those shown in FIGS. 11A and 11B and meshes such as those shown in FIGS. 13A and 13B, and FIG. 15B shows the percentage of steatosis as a function of position in the image slice of the tissue based on computational channels such as those shown in FIGS. 10A and 10B, and meshes such as those shown in FIGS. 12A and 12B.

FIG. 16 illustrates states of liver disease and histological characteristics.

FIG. 17 illustrates an example of segmentation of a prostate biopsy sample using the systems and methods described herein.

### DETAILED DESCRIPTION

The terminology used herein is for the purpose of describing particular embodiments only and is not intended to limit the full scope of the claims. Unless defined otherwise, all technical and scientific terms used herein have the same meanings as commonly understood by one of ordinary skill in the art.

As used in this specification, the singular forms “a,” “an,” and “the” include plural referents unless the context clearly dictates otherwise. For example, the term “a member” is intended to mean a single member or a combination of members, “a material” is intended to mean one or more materials, or a combination thereof. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims, are generally intended as “open” terms (e.g., the term “including” should be interpreted as “including but not limited to,” the term “having” should be interpreted as “having at least,” etc.). For example, the terms “comprise(s)” and/or “comprising,” when used in this specification, are intended to mean “including, but not limited to.” While such open terms indicate the presence of stated features, integers (or fractions thereof), steps, operations, elements, and/or components, they do not preclude the presence or addition of one or more other features, integers (or fractions thereof), steps, operations, elements, components, and/or groups thereof, unless expressly stated otherwise.

As used herein the term “and/or” includes any and all combinations of one or more of the associated listed items. Said another way, the phrase “and/or” should be understood to mean “either or both” of the elements so conjoined (i.e., elements that are conjunctively present in some cases and disjunctively present in other cases). It should be understood that any suitable disjunctive word and/or phrase presenting two or more alternative terms, whether in the description, claims, or drawings, contemplate the possibilities of including one of the terms, either of the terms, or both terms. Other elements may optionally be present other than the elements specifically identified by the “and/or” clause, whether related or unrelated to those elements specifically identified. Thus, as a non-limiting example, a reference to “A and/or B” can refer to “A” only (optionally including elements other than “B”), to “B” only (optionally including elements other than “A”), to both “A” and “B” (optionally including other elements), etc.

As used herein, “or” should be understood to have the same meaning as “and/or” as defined above. For example, when separating items in a list, “or” or “and/or” shall be interpreted as being inclusive (e.g., the inclusion of at least one, but also including more than one, of a number or list of elements, and, optionally, additional unlisted items). Only terms clearly indicated to the contrary, such as when modified by “only one of” or “exactly one of” (e.g., only one of “A” or “B,” “A” or “B” but not both, and/or the like) will refer to the inclusion of exactly one element of a number or list of elements.

As used herein, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements, unless expressly stated otherwise. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B” or “at least one of A and/or B”) can refer to one or more “A” without “B,” one or more “B” without “A,” one or more “A” and one or more “B,” etc.

All ranges disclosed herein are intended to encompass any and all possible subranges and combinations of subranges thereof unless expressly stated otherwise. Any listed range should be recognized as sufficiently describing and enabling the same range being broken down into at least equal subparts unless expressly stated otherwise. As will be understood by one skilled in the art, a range includes each individual member and/or a fraction of an individual member where appropriate.

As used herein, the terms “about,” “approximately,” and/or “substantially” when used in connection with stated value(s) and/or geometric structure(s) or relationship(s) is intended to convey that the value or characteristic so defined is nominally the value stated or characteristic described. In some instances, the terms “about,” “approximately,” and/or “substantially” can generally mean and/or can generally contemplate a value or characteristic stated within a desirable tolerance (e.g., plus or minus 10% of the value or characteristic stated). For example, a value of about 0.01 can include 0.009 and 0.011, a value of about 0.5 can include 0.45 and 0.55, a value of about 10 can include 9 to 11, and a value of about 100 can include 90 to 110. Similarly, a first surface may be described as being substantially parallel to a second surface when the surfaces are nominally parallel. While a value, structure, and/or relationship stated may be desirable, it should be understood that some variance may occur as a result of, for example, manufacturing tolerances or other practical considerations (such as, for example, the pressure or force applied through a portion of a device, conduit, lumen, etc.). Accordingly, the terms “about,” “approximately,” and/or “substantially” can be used herein to account for such tolerances and/or considerations.

As used herein, the term “set” can refer to multiple features, components, members, etc. or a singular feature, component, member, etc. with multiple parts. For example, when referring to a set of walls, the set of walls can be considered as one wall with multiple portions, or the set of walls can be considered as multiple, distinct walls. Thus, a monolithically constructed item can include a set of walls. Such a set of walls may include multiple portions that are either continuous or discontinuous from each other. A set of walls can also be fabricated from multiple items that are produced separately and are later joined together (e.g., via a weld, an adhesive (glue, etc.), mechanical fastening such as stitching, stapling, etc., or any suitable method).

As used herein, the term “bricking” refers to chunking or breaking of raw image data into smaller pieces or images that can be used to form an image pyramid and makes the portions suitable for parallel processing.

Microscopy is a powerful tool used for many applications including for the analysis of biological structures. Microscopic examination of tissue is often used to characterize tissue samples, identify and/or quantify biomarkers in samples, detect abnormal tissue, diagnose patient disease, evaluate response to therapy, etc. However, many limitations exist in current microscopy techniques particularly those used in pathology, which negatively impacts results and patient outcomes. For example, pathology laboratories handle biopsies using a process that only samples a small fraction (˜1%) of the collected specimens, thereby resulting in a large degree of uncertainty in diagnosis. Furthermore, current pathology methods rely on 2D tissue data collected with glass slides, which consumes valuable tissue, provides a limited and often misleading view of tissue structures, and takes days to obtain results.

Studies on kidney disease, neuron-tracing, and tumor blood vessel density have demonstrated the superiority of 3D data over 2D data for analyzing complex microscopic structures. However, current 3D microscopy techniques are limited in that they require manual input at multiple steps in the imaging process, which limits their ability for high throughput for pharma and clinical applications. In a typical 3D microscopy workflow, a user may need to find imaging bounds of each tissue sample, identify one or more regions of interest, and/or determine bounds for the one or more regions of interest. This type of manual analysis is ill-suited for the collection and analysis of complex biological tissue in 3D due to the large size of datasets 3D imaging generates (e.g., datasets can often be 1 TB or larger in size). Visual examination and manual annotation of such datasets can take hours. Therefore, there is a need for systems and methods capable of efficiently collecting and analyzing complex biological structures in 3D.

The apparatuses, systems, and methods described herein address the shortcomings of current microscopy technologies by, for example: (1) enabling automation of 2D and/or 3D microscopy data collection, thereby reducing amount of labor required for experiments; (2) increasing efficiency of collecting 3D datasets; (3) improving efficacy of drug development; (4) accelerating the process of drug development; (5) enabling easier analysis of human biopsies; (6) enabling examination of a large amount of a biopsy sample (100-250× more tissue than traditional methods), thereby enabling more accurate biopsy analysis (7) improving clinical diagnostic accuracy; (8) reducing memory storage used by only capturing and storing and/or transmitting high resolution images of ROIs identified in a sample such as a tissue sample, thereby reducing computing power used as well as computing time; (9) using machine learning models to facilitate identification of ROIs, thus further reducing analysis time and accuracy; and (10) providing a user-friendly interface for 2D and/or 3D data collection and analysis. Additionally, using 3D microscopy data instead of 2D slide-based data for pathology has further advantages including preserving tissue for important molecular tests, reducing susceptibility to variable histology quality, and improving accuracy of machine learning analysis of data.

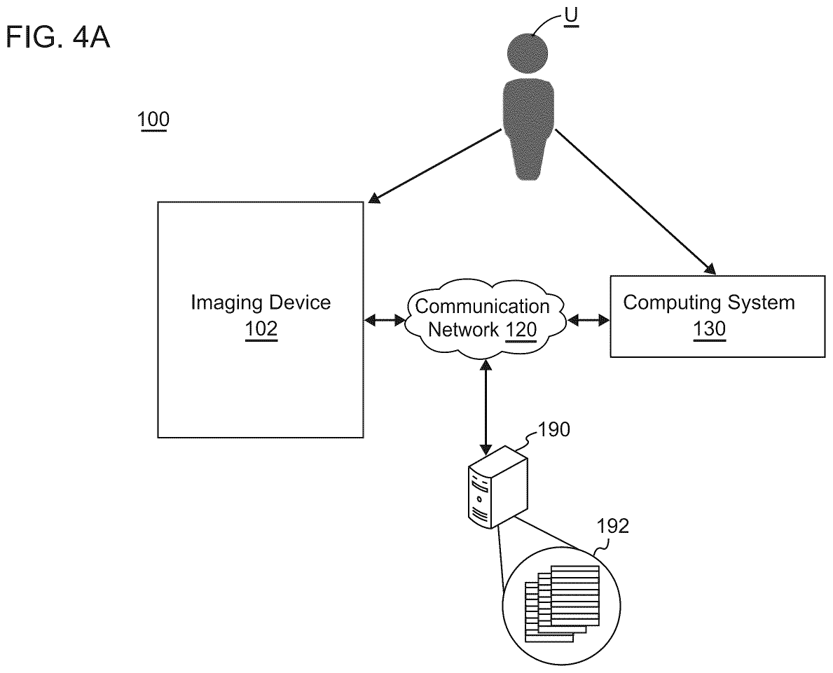

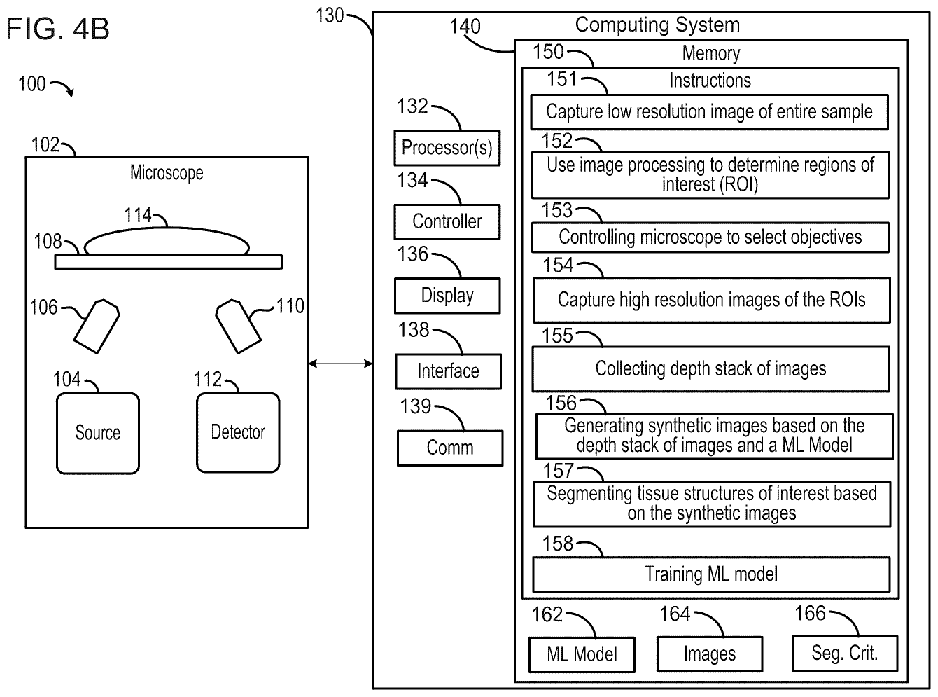

Referring now to the drawings, FIG. 4A is a schematic block diagram illustration of a system 100 including an imaging device 102 (e.g., a microscope), and a computing system 130, and optionally, a communication network 120, according to an embodiment. FIG. 4B is a schematic block diagram of the system 100 of FIG. 4A illustrating components or instructions that may be included in the imaging device 102 and the computing system 130 of FIG. 4A, according to a particular embodiment.

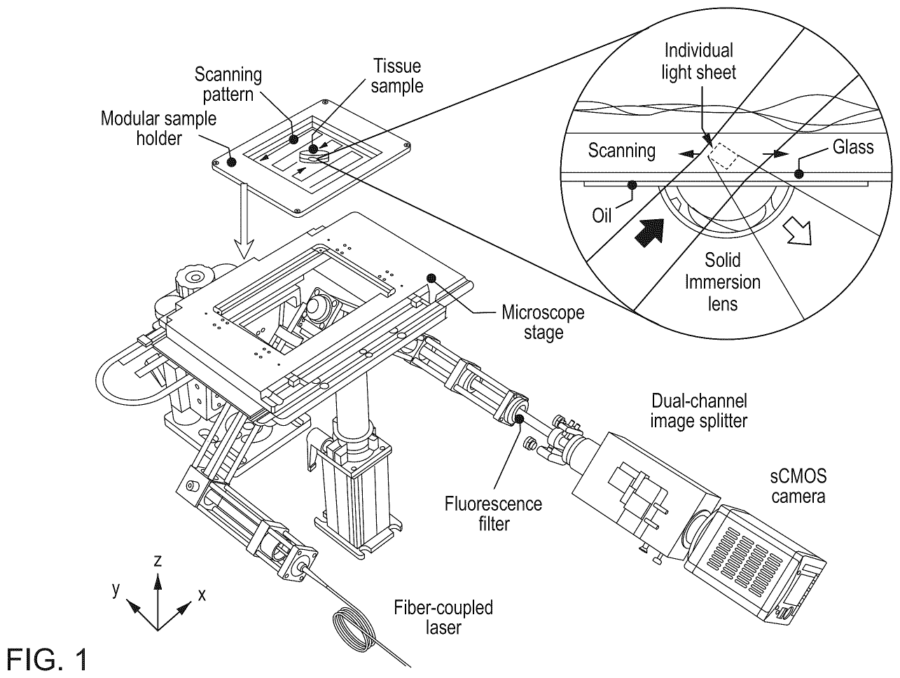

The system 100 includes an imaging device 102 (e.g., a microscope such as, for example, the OTLS microscope shown in FIG. 1)) and a computing system 130 which operates the imaging device 102 and/or interprets information from the imaging device 102. In some embodiments, one or more parts of the computing system 130 may be integrated into the imaging device 102. In some embodiments, the computing system 130 may be a stand-alone component (e.g., a commercial desktop computer) which is communicatively coupled to the imaging device 102. In some embodiments, the computing system 130 may be remote from the imaging device 102 and may not directly operate or communicate with the imaging device 102. For example, the images (e.g., microscopic images) may be captured in a first location, and then loaded onto the computing system 130 at some later time in a second location (e.g., via removable media, wired or wireless communication, etc.). In some embodiments, the imaging device 102 may include an optical imaging device configured to capture images in 2D and/or 3D. In some embodiments, the imaging device 102 may include a microscope configured to capture 3D images of biological structures such as, for example, a light-sheet microscope (e.g., open-top light-sheet microscope, single-objective light-sheet microscope, light-sheet theta microscope, etc.), a confocal microscope (laser scanning confocal microscope and/or spinning disk confocal microscope), a 2-photon microscope, a 3-photon microscope, or any other suitable microscope. In some embodiments, the imaging device 102 may be configured to capture images at more than one level of resolution. For example, the imaging device 102 may be a microscope including a first set of optics configured to capture a sample at a low resolution (e.g., one or more low resolution objectives), and a second set of optics configured to capture a sample at high resolution (e.g., one or more high resolution objectives).

The imaging device 102 may include a source 104 which generates illumination light and illumination optics 106 which direct the illumination light onto a sample 114. The microscope includes collection optics 110 which receive light from the sample 114 and direct the received light onto a detector 112. The illumination and collection optics 106 and 110 may each reshape, filter or otherwise alter the light passing through them. The detector 112 generates one or more signals which represent a captured image of the received light. In some embodiments, a sample holder 108 may be used to support the sample 114. In some embodiments, the collection optics 110 may include a first objective (or a first set of objectives) configured to capture low-resolution image data (e.g., the low resolution objective(s)) and a second objective (or a second set of objectives) configured to capture high-resolution image data (e.g., the high resolution objective(s)). In some embodiments, the first objective may have a first numerical aperture (NA), and the second objective may have a second NA greater than the first NA. In some embodiments, the first objective may be a 10× objective or having an NA of about 0.21, and the second NA may be a 20× objective or higher or having an NA between 0.30 to 0.95. In some embodiments, the imaging device 102 may be configured to capture images having a lateral resolution between about 1 μm to about 12.8 μm using the first objective, and the collection optics 110 using the second objective may be configured to capture images with a lateral resolution between about 0.2 μm to about 1.2 μm. In some embodiments, the imaging device 102 can be manually and/or automatically transitioned between collecting low-resolution images and high-resolution images. While FIG. 4A shows a particular configuration of the imaging device 102, this is for illustration purposes only, and the imaging device 102 may include any imaging device capable of capturing low resolution and high resolution images as described herein. For example, in some implementations, the imaging device 102 may include the OTLS microscope shown in FIG. 1. In some implementations, the imaging device 102 may include any imaging device shown and described in the '656 patent.

The detector 112 may include a CMOS chip or any other detector having a plurality of pixels configured to detect optical signals received from the sample through the first objective or the second objective, and generate electrical signals that are indicative of the optical signals. In some embodiments, the computing system 130 may be configured to down sample the optical signals received from the sample by the detector 112 (e.g., when capturing a low resolution image of the sample, as described herein). For example, the down sampling may include sampling or processing signals from less than all of the active pixels of the detector 112. This may reduce image size, thus reducing memory usage and computing power, and increasing processing time.

While a particular arrangement and type of microscope may be described herein, it should be understood that the disclosure is not limited to any one microscope or type of microscope. For example, some embodiments may include a microscope in which a single objective is used as part of both the illumination and collection optics 106 and 110 and/or in which a fiber is used to image a sample 114 which is an in vivo tissue.

The computing system 130 may include one or more of a processor 132 which executes various operations in the computing system 130, a controller 134 which may send and receive signals to operate the imaging device 102 and/or any other devices based on instructions from the processor 132, a display 136 which presents information to a user, an interface 138 which allows a user to operate the computing system 130, and a communications module 139 which may send and receive data (e.g., images from the detector 112). The computing system 130 includes a memory 140, which includes various instructions 150 which may be executed by the processor 132.

In some embodiments, the processor 132 of the computing system 130 is communicatively coupled to the imaging device 102 to send signals to and/or receive signals from the imaging device 102. In some embodiments, the computing system 130 may be configured to send instructions to the imaging device 102 to capture 2D and/or 3D images and/or to receive information relating to the images captured by the imaging device 102. In some embodiments, the computing system 130 may be configured to process and/or analyze the image data and/or store raw and/or processed image data. In some embodiments, the computing system 130 may be configured to control the imaging device 102 based on the processing and/or analysis of the image data. For example, the computing system 130 may control the imaging device 102 to capture low resolution images, process and/or analyze the low resolution images to detect ROIs, and then subsequently control the imaging device 102 to capture high resolution images of the detected ROIs.

In some embodiments, the imaging device 102 and the computing system 130 may be configured to interface with a user U such that the user U can control the imaging device 102 and/or computing system 130 to collect imaging data. For example, the computing system 130 may be configured to receive inputs from the user U such as inputs to control imaging parameters of the imaging device 102 (e.g., low or high resolution, location to image, wavelength of light, etc.) and/or to control the image processing and/or analysis (e.g., manually selecting ROIs).

In some embodiments, the imaging device 102 and/or the computing system 130 may optionally communicate, via the communication network 120, to an external device 190. The external device 190 is, for example, a remote server, a cloud server, or a remote computer that can be used to receive data or information from the computing system 130, process some or all of the data, provide instructions or signals to the computing system 130 corresponding to processed images, and/or update instructions (e.g., software updates), etc. For example, image data collected by the imaging device 102 may be sent via the communication network 120 to the computing system 130 and/or the external device 190. The external device 190 (e.g., the remote server) may optionally include an edge computing system, and/or parallel processing computing system. The external device 190 may also include a database 192 configured to store low-resolution and/or high-resolution image data, processed image data, and/or instructions for communicating to the computing system 130.

In some embodiments, the imaging device 102 and/or computing system may send imaging data to the external device 190 via the communication network 120, and the external device 190 upon receiving the imaging data may be configured to execute code and/or instructions stored on the external device 190 to process and/or analyze the imaging data. In some embodiments, the computing system 130 and the external device 190 may be configured to process and/or analyze the imaging data simultaneously or in parallel.

As described in more detail herein, the instructions 150 may cause the processor 132 to generate synthetic images based on a set of images (e.g., a depth stack) taken of the sample 114 using a trained machine learning (ML) model 162 or artificial intelligence (AI) model. The images may be collected based on a first labelling technique while the synthetic images may predict a second labelling technique which is targeted to a biomarker in the sample 114. The ML model 162 may be trained using the computing system 130 or may be trained separately and provided to the computing system 130 as a pre-trained model. In some embodiments, one or more components/processes may be remote. For example, in some embodiments, the trained ML model 162 may be located on the external device 190 (e.g., a server) and the computing system 130 may send images 164 to the server and receive synthetic images back. The sample 114 may be prepared with one or more labelling techniques, which may be used to visualize one or more aspects of the sample 114. As used herein, ‘labelling technique’ may refer both to any preparation of the sample and any corresponding imaging modes used to generate images of the sample. For example, if the labelling technique involves a fluorophore, then imaging the sample with the labelling technique may also include using fluorescent microscopy to image the fluorophore. Labelling techniques may include various sample preparation steps, such as washing, optical clearing, mounting, and other techniques known in the art. Some labelling techniques may include applying exogenous contrast agents (e.g., fluorescent dyes, stains, etc.) to the sample 114. Some labelling techniques may rely on inherent optical properties of the sample 114 (e.g., endogenous fluorophores, relying on tissue pigmentation, darkfield) and may not need additional contrast agents.

Some labelling techniques may include ‘label-free’ imaging, where some inherent optical property of the tissue is imaged without the need to apply an exogenous contrast agent. For example, fluorescent imaging may be used to image endogenous fluorophores of the tissue, without the need to add additional fluorophores to the sample. Label free imaging techniques may still include sample preparation steps such as sectioning or optical clearing. Some label-free imaging techniques may be specific, such as second harmonic generation (SHG) imaging, which may be used to specifically target collagen fibers due to the unique “noncentrosymmetric” molecular structure of those fibers.

Sample 114 may be prepared using multiple labelling techniques. For example, a stain may be applied as well as a fluorescent dye, and the sample may be imaged using brightfield to capture the stain and fluorescent imaging to capture the dye. In another example, multiple stains may be used together and may all be captured by the same imaging mode (e.g., multiple dyes may be visualized using a single brightfield image). In another example, multiple different fluorescent dyes may be used, and the imaging device 102 may use a first set of filters (e.g., a first excitation filter and emission filter) to image a first fluorescent dye, a second set of filters to image a second fluorescent dye, etc. If multiple labelling techniques are used on the same sample 114, then it may be possible for the imaging device 102 to capture multiple images of a given field of view, each imaging a different label.

Some labelling techniques are specifically targeted to the tissue of interest, and others are less specific. Targeted labelling techniques may include contrast agents with a targeting moiety and a signal-generation moiety. The targeting moiety may be used to selectively cause the signal-generation moiety to be localized in all or part of the tissue structure of interest. For example, the targeted moiety may selectively bind to a biomarker which is associated with the tissue of interest. For example, if the tissue structure of interest is a particular type of fibrosis, then the targeting moiety may be used to target a biomarker expressed in those fibrotic structures but not in other cells and tissue components, or overexpressed in those fibrotic structure compared to other tissues, or not present in those fibrotic structures but present in other tissues. Another example of a targeted moiety may include chemicals which are selectively up taken by tissues. For example, glucose analogues may be taken up by cancerous cells at a much higher rate than non-cancerous cells. The targeting moiety may be any marker which allows for visualization under one or more imaging modes. For example, fluorophores or dyes may be attached to the targeting moiety. In some embodiments, the targeting moiety may be bound to an signal generation moiety to form a contrast agent (e.g., an antibody bound to a fluorophore). In some embodiments, the targeting moiety and signal-generation moiety may be an inherent properties of the contrast agent. For example, fluorescent glucose analogues may both be fluorescent and target cancerous cells. Examples of targeting moieties that may be used as part of a targeted labelling technique include aptamers, antibodies, peptides, nanobodies, antibody fragments, enzyme-activated probes, and fluorescent in situ hybridization (FISH) probes.

Some labelling techniques are less specific and may be used to image general tissue structures and/or broad types of tissue without specifically targeting any tissue structure of interest. For example, common cell stains, such as hematoxylin and eosin (H&E) or their analogs, may generally stain cellular nuclear material and cytoplasm respectively, without targeting any particular nuclear or cytoplasmic material. Examples of less specific labelling techniques include H&E analogs, Mason's tri-chrome, periodic acid-Schiff (PAS), 4′, 6-diamidino-2-phenylindole (DAPI), and unlabeled imaging of tissue. In addition, endogenous signals, imaged without external contrast agents, can also be used as part of a label free imaging technique to provide general tissue contrast. For example, reflectance microscopy and autofluorescence microscopy are examples of “label-free” imaging techniques that generate images that reveal a variety of general tissue structures.

Labelling techniques may be multiplexed. For example, a sample 114 may be labelled with an H&E analogue and also a fluorescent antibody targeted to a biomarker expressed only by a specific tissue structure of interest (e.g., a specific type of tissue or cell). The images generated using the fluorescent antibody will only (or primarily) show the structure of interest, since the fluorophore is only (or primarily) bound to that specific tissue type. The images generated using the H&E analogue labelling technique will also show that type of tissue (since all tissues include nuclear and cytoplasmic material), but will also show other types of tissue. Accordingly, the tissue structure of interest may still be detected in images generated using a less specific labelling technique, but identification of those features of interest may be more difficult.

The less specific labelling techniques (e.g., H&E analogs) may offer various advantages. For example, targeted labelling techniques (e.g., immunofluorescence) may use contrast agents with relatively high molecular weights (e.g., >10 kDa) compared to the low molecular weights (e.g., <10 kDa) of more general contrast agents. Accordingly, when 3D imaging is desired, it may take a relatively long amount of time for targeted contrast agents to diffuse through the sample. This may be impractical for some applications and may dramatically increase the time and cost of preparing and imaging a sample. The less specific labeling techniques may also enable multiple structures to be identified and segmented, rather than requiring multiplexed staining and imaging with many highly specific targeted contrast agents.

Embodiments of the present disclosure are not limited to any particular type or design of microscope. However, for purposes of explanation, a particular layout of a microscope is shown as the imaging device 102 of FIG. 4. In particular, the imaging device 102 shown in FIG. 4 is an inverted microscope in which the collection optics 110 are located below the sample 114 and sample holder 108. More specifically, the imaging device 102 may be an open top light sheet (OTLS) microscope, where the illumination and collection optics are separate, and wherein a principle optical axis of the illumination path is at an angle (e.g., orthogonal to) the principle optical axis of the collection path. The illumination light may be focused to a light sheet (e.g., focused such that it is much wider than it is thick) which may offer advantages in terms of 3D imaging of samples at high speeds using fast cameras 114. The OTLS microscope shown in FIG. 1 is also exemplary of imaging device 102. Similarly, a suitable, exemplary OTLS microscope is disclosed in the incorporated '656 patent.

The source 104 provides illumination light along an illumination path to illuminate a focal region of the sample 114. The source 104 may be a narrow band source, such as a laser or a light emitting diode (LED) which may emit light in a narrow spectrum. In some embodiments, the light may be a broadband source (e.g., an incandescent source, an arc source) which may produce broad spectrum (e.g., white) illumination. In some embodiments, one or more portions of the illumination light may be outside of the visible range. In some embodiments, a filter (not shown) may be used as part of the illumination optics 106 to further refine the wavelength(s) of the illumination light. For example, a bandpass filter may receive broadband illumination from the source 104, and provide illumination light in a narrower spectrum. In some embodiments, the light source 104 may be a laser, and may generate collimated light.

In some embodiments, the imaging device 102 may have multiple imaging modes (e.g., brightfield, fluorescence, phase contrast microscopy, darkfield), which may be selectable. For example, in some embodiments, the imaging device 102 may be used to image fluorescence in the sample 114. The illumination light may include light at a particular excitation wavelength, which may excite fluorophores in the sample 114. The fluorophores may be endogenous to the sample and/or may be exogenous fluorescent labels applied to the sample. The illumination light may include a broad spectrum of light which includes the excitation wavelength, or may be a narrow band centered on the excitation wavelength. In some embodiments, the light source 104 may produce a narrow spectrum of light centered on (or close to) the excitation wavelength. In some embodiments, filter(s) (not shown) may be used in the illumination optics 106 to limit the illumination light to wavelengths near the excitation wavelength. Once excited by the illumination light, the fluorophores in the sample 114 may emit light (which may be centered on a given emission wavelength). The collection path (e.g., collection optics 110) may include one or more filters which may be used to limit the light which reaches the detector 112 to wavelengths of light near the emission wavelength. In some embodiments, the imaging device 102 may have multiple sets of illumination and/or collection filters and which fluorophore(s) are currently imaged may be selectable.

The illumination optics 106 may direct the light from the source 104 to the sample 114. For example, the illumination optics 106 may include an illumination objective which may focus the light onto the sample 114. In some embodiments, the illumination optics 106 may alter the shape, wavelength, intensity and/or other properties of the light provided by the source 104. For example, the illumination optics 106 may receive broadband light from the source 104 and may filter the light (e.g., with a filter, diffraction grating, acousto-optic modulator, etc.) to provide narrow band light to the sample 114.

In some embodiments, the illumination path may provide an illumination beam which is a light sheet as part of light sheet microscopy or light-sheet fluorescent microscopy (LSFM). The light sheet may have a generally elliptical cross section, with a first numerical aperture along a first axis (e.g., the y-axis) and a second numerical aperture greater than the first numerical aperture along a second axis which is orthogonal to the first axis. The illumination optics 106 may include optics which reshape light received from the source 104 into an illumination sheet. For example, the illumination optics 106 may include one or more cylindrical optics which focus light in one axis, but not in the orthogonal axis.

In some embodiments, the illumination optics 106 may include scanning optics, which may be used to scan the illumination light relative to the sample 114. For example, the region illuminated by the illumination beam may be smaller than a focal region of the collection optics 110. In this case, the illumination optics 106 may rapidly oscillate the illumination light across the desired focal region to ensure illumination of the focal region.

The sample holder 108 may position the sample 114 such that the illumination region and focal region is generally within the sample 114. The sample 114 may be supported by an upper surface of the sample holder 108. In some embodiments, the sample 114 may be placed directly onto the upper surface of the sample holder 108. In some embodiments, the sample 114 may be packaged in a container (e.g., on a glass slide, in a well plate, in a tissue culture flask, etc.) and the container may be placed on the sample holder 108. In some embodiments, the container may be integrated into the sample holder 108. In some embodiments, the sample 114 may be processed before imaging on the optical system 100. For example, the sample 114 may be washed, sliced, and/or labelled before imaging.

In some embodiments, the sample 114 may be a biological sample. For example, the sample 114 may be a tissue which has been biopsied from an area of suspected disease (e.g., cancer). Other example samples 114 may include cultured cells, or in vivo tissues, whole organisms, or combinations thereof. In some embodiments, the tissue may undergo various processing, such as optical clearance, tissue slicing, and/or labeling before being examined by the optical system 100.

The sample holder 108 may support the sample 114 over a material which is generally transparent to illumination beam and to light collected from the focal region of the sample 114. In some embodiments, the sample holder 108 may have a window of the transparent material which the sample 114 may be positioned over, and a remainder of the sample holder 108 may be formed from a non-transparent material. In some embodiments, the sample holder 108 may be made from a transparent material. For example, the sample holder 108 may be a glass plate.

The sample holder 108 may be coupled to an actuator (not shown), which may be capable of moving the sample holder 108 in one or more directions. In some embodiments, the sample holder 108 may be movable in up to three dimensions (e.g., along the x, y, and z axes) relative to the illumination optics 106 and collection optics 110. The sample holder 108 may be moved to change the position of the focal region within the sample 114 and/or to move the sample holder 108 between a loading position and an imaging position. In some embodiments, the actuator may be a manual actuator, such as screws or coarse/fine adjustment knobs. In some embodiments, the actuator may be automated, such as an electric motor, which may respond to manual input and/or instructions from a controller 134 of the computing system 130. In some embodiments the actuator may respond to both manual adjustment and automatic control (e.g., a knob which responds to both manual turning and to instructions from the controller 134).

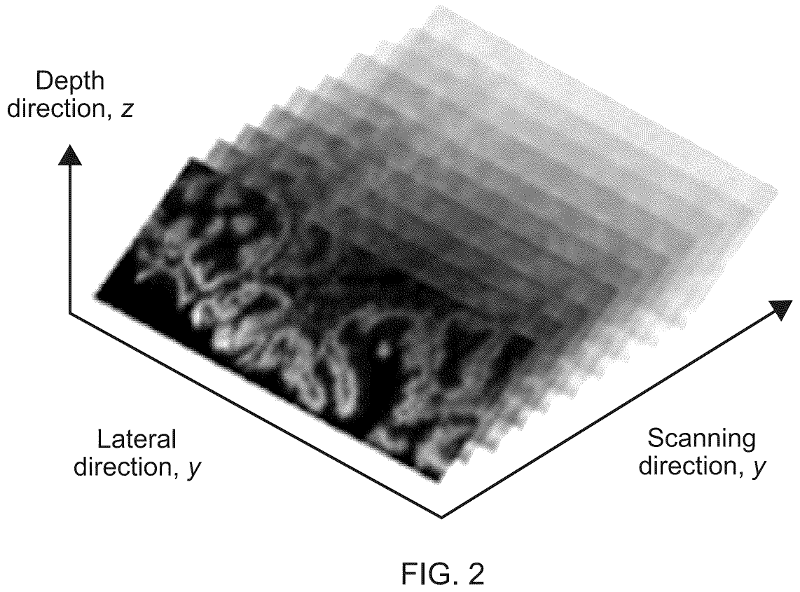

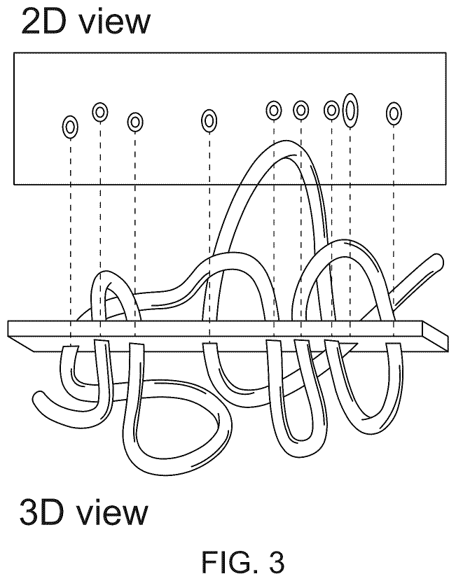

The imaging device 102 may be used to generate a depth stack (or z-stack) of images, such as those shown in FIG. 2. For example the actuator may position the sample 114 such that a first image is taken with the image being generally in an x-y plane. The actuator may then move the sample 114 a set distance along an axis orthogonal to the imaging plane (e.g., along the z-axis), and a second image may be captured. This may be repeated a number of times to build up a set of 2D images which represent a 3D volume of the sample 114. In some embodiments, multiple depth stacks may be collected by generating a depth stack at a first location and then moving the sample holder along the x and/or y-axis to a second location and generating another depth stack. The depth stacks may be mosaicked together to generate a 3D mosaic of a relatively large sample.

In some embodiments, the optical system 100 may collect depth stacks of relatively thick tissue samples. For example, in some embodiments the depth stack may be greater than 5 um thick. In some embodiments, the sample 114 may be larger, such as biopsy samples, and the depth stacks may be a millimeter or more thick.

The collection optics 110 may receive light from a focal region and direct the received light onto a detector 114 which may image and/or otherwise measure the received light. The light from the focal region may be a redirected portion of the illumination beam (e.g., scattered and/or reflected light), may be light emitted from the focal region in response to the illumination beam (e.g., via fluorescence), or combinations thereof.

The collection optics 110 collect light from the sample 114 and direct that collected light onto the detector 112. For example, the collection optics 110 may include a collection objective lens. In some embodiments, the collection optics 110 may include one or more elements which alter the light received from the sample 114. For example, the collection optics 110 may include filters, mirrors, de-scanning optics, or combinations thereof.

The detector 112 may be used for imaging the focal region. In some embodiments, the detector 112 may include an eyepiece, such that a user may observe the focal region. In some embodiments, the detector 112 may produce a signal to record an image of the focal region. For example, the detector 112 may include a CCD or CMOS array, which may generate an electronic signal based on the light incident on the array.

The imaging device 102 may be coupled to a computing system 130 which may be used to operate one or more parts of the imaging device 102, display data from the imaging device 102, interpret/analyze data from the imaging device 102, or combinations thereof. In some embodiments, the computing system 130 may be separate from the microscope, such as a general purpose computer. In some embodiments, one or more parts of the computing system 130 may be integral with the imaging device 102. In some embodiments, one or more parts of the computing system may be remote from the imaging device 102.

The computing system 130 includes a processor 132, which may execute one or more instructions 150 stored in a memory 140. The instructions 150 may instruct the processor 132 to operate the imaging device 102 (e.g., via controller 134) to collect images 164, which may be stored in the memory 140 for analysis. The images 164 may be analyzed ‘live’ (e.g., as they are collected or shortly thereafter) or may represent previously collected imaging. In some embodiments, the computing system 130 may be remotely located from the microscope and may receive the images 164 without any direct interaction with the imaging device 102. For example, the imaging device 102 may upload images to an external device 190 (e.g., a server) via the communication network 120, and the communications module 139 of the computing system 130 may download the images 164 to the memory 140 for analysis.

The images 164 may represent one or more depth stacks of the sample 114. Each depth stack is a set of images which together represent slices through a 3D volume of the sample 114. The images 164 may include metadata (e.g., a distance between slices along the z-axis) which allows for orientation of the images (e.g., a reconstruction of the 3D volume). Multiple 3D volumes (e.g., multiple depth stacks) may be mosaicked together to form a larger overall 3D volume.

The processor 132 can be any suitable processing device(s) configured to run and/or execute a set of instructions or code. For example, the processor 132 can be and/or can include one or more data processors, image processors, graphics processing units (GPU), physics processing units, digital signal processors (DSP), analog signal processors, mixed-signal processors, machine learning processors, deep learning processors, finite state machines (FSM), compression processors (e.g., for data compression to reduce data rate and/or memory requirements), encryption processors (e.g., for secure wireless data and/or power transfer), and/or the like. The processors 132 can be, for example, a general-purpose processor, central processing unit (CPU), edge computing and/or edge AI processor, edge machine learning processor, and/or the like. In some embodiments, the computing system 130 includes a high-power graphics processing unit (GPU) such that an amount of time to process and/or analyze the image data (e.g., a large 3D image dataset) is lower than if processed and/or analyzed with a general-purpose processor. In some embodiments, the processor 132 includes a set of processors operatively coupled to each other in parallel such that the processors 132 can process and/or analyze data in parallel. In some embodiments, the processor(s) 132 may process and/or analyze the image data in near real-time such that the user can view the processed image data while operating the imaging device 102. In some embodiments, the external device 190 may include one or more processors similar to those described herein. In some embodiments, the external device 190 may include a remote server, or a cloud server, that may include a database 192 configured to store image data or other information received from the computing system 130 and/or the imaging device 102.

The memory 140 can be, for example, a random access memory (RAM), a memory buffer, a hard drive, a database, an erasable programmable read-only memory (EPROM), an electrically erasable read-only memory (EEPROM), a read-only memory (ROM), and/or so forth. In some embodiments, the computing system 130 is coupled to a database for storing instructions, raw and/or processed image data, one or more algorithms for analyzing the image data, etc. In some embodiments, the memory 140 stores executable instructions 150 that cause processor(s) 132 to execute operations, modules, processes, and/or functions associated with controlling the imaging device 102 and processing and/or analyzing image data from imaging device 102. While the instructions 150 are described as being stored in the memory 140 of the computing system 130, the instructions 150 (or a subset of the instructions 150) may additionally or alternative by stored in the database 192 of the external device 190. In some embodiments, the database 192 may be configured to store raw and/or processed image data and/or one or more algorithms for imaging processing (e.g., deep learning algorithm, Convolution Neural Network (CNN), ML algorithm, etc.). In some embodiments, stored information and/or instructions may be transmitted between the computing system 130 and the external device 190 via the communication network 120.

The communication network 120 may include any suitable Local Area Network (LAN) or Wide Area Network (WAN). For example, the communication network 120 can be supported by Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS) Wideband Code Division Multiple Access (WCDMA), Long Term Evolution (LTE), evolved Multimedia Broadcast Multicast Services (eMBMS), High-Speed Downlink Packet Access (HSDPA), and the like), Universal Terrestrial Radio Access (UTRA), Global System for Mobile Communications (GSM), Code Division Multiple Access 1x Radio Transmission Technology (1x), General Packet Radio Service (GPRS), Personal Communications Service (PCS), 802.11X, ZigBee, Bluetooth, Wi-Fi, any suitable wired network, combination thereof, and/or the like. The communication network 120 is structured to permit the exchange of data, values, instructions, messages, and the like between the computing system 130, the imaging device 102, and, optionally, an external device 190.

The display 136 may include a touchscreen, or any other suitable display configured to display image data, other information, and may also be configured to receive inputs from the user. The interface 138 may include one or more devices configured to allow a user to interface with the computing system 130 such as, for example, a keyboard, mouse, trackball, touch pen, etc. The communications module 139 can be any suitable device(s) and/or interface(s) that can communicate with the imaging device 102, a network (e.g., a local area network (LAN), a wide area network (WAN), or the cloud), or an external device (e.g., a user device such as cell phone, tablet, a laptop, or a desktop computer, etc.). Moreover, the communications module 139 can include one or more wired and/or wireless interfaces, such as, for example, Ethernet interfaces, optical carrier (OC) interfaces, and/or asynchronous transfer mode (ATM) interfaces. In some embodiments, the communications module 139 can be, for example, a network interface card and/or the like that can include at least an Ethernet port and/or a wireless radio (e.g., a WI-FI® radio, a BLUETOOTH® radio, cellular such as 3G, 4G, 5G, etc., 802.11X Zigbee, etc.). In some embodiments, the communications module 139 can include one or more satellite, WI-FI, BLUETOOTH, or cellular antenna. In some embodiments, the communications module 139 can be communicably coupled to an external device (e.g., an external processor) that includes one or more satellite, WI-FI®, BLUETOOTH®, or cellular antenna, or a power source such as a battery or a solar panel. In some embodiments, the communications module 139 can be configured to receive imaging or video signals from the imaging device 102, the transmit signals to the imaging device 102, for example, for moving the sensors. In some embodiments, the communications module 139 may also be configured to communicate signals to imaging device 102, for example, an activation signal to activate the imaging device 102 (e.g., one or more imagers and/or electromagnetic radiation sources included in the imaging device 102), move the objectives of the imaging device 102, or the sample holder 108.

The instructions 150 include steps which direct the computing system 130 to operate the imaging device 102 to collect images. For example, instructions 151 may include instructing the processor(s) 132 to control the imaging device 102 via the controller 134 to collect a depth stack of low resolution images of an entire sample. The instructions 151 may cause the processor 132 to transmit a first signal to the imaging device 102 configured to cause the imaging device 102 to capture the low resolution images of the sample. The instructions 151 may include capturing a first image from the detector 112, moving the sample holder 108 a set distance (e.g., along a z-axis) capturing a second image, and so forth until a set number of images and/or a set distance along the z-axis has been achieved. In some embodiments, the instructions 151 may also include displacement along one or more other axes. For example, some microscope geometries may have images which do not lie in an x-y plane, and thus more complicated movements may be required to capture a stack of images. The instructions 151 may include instructions to cause the actuator to move the low resolution objective to a predetermined location to begin imaging of the sample in low resolution. In some embodiments, the instructions 151 may cause the actuator to move the sample holder such that the low resolution objective is aligned with the sample to begin imaging in low resolution. In some embodiments, the instructions 151 may be performed by a different computing system than the one which analyzes the images (e.g., the external device 190 or a supplemental device).

In some embodiments, collecting the low resolution images may include collecting or capturing images with the high resolution objective and down sampling the optical signals collected or received by the detector 112, as previously described herein. In some embodiments, collecting the low resolution image may include collecting or capturing images with the low resolution objective and down sampling the optical signals collected or received by the detector 112.

The processor 132 may be configured to receive the low-resolution images for processing and/or storage in the memory 140. At 152, the instructions 150 may control the processor 132 of the computing system 130 and/or one or more processor associated with the external device 190 to perform one or more image processing operations to determine regions of interest (ROI) in the low resolution images. The one or more imaging operations may be executed to obtain optimized image data for analysis. For example, the computing system 130, upon receiving the low resolution images, may be configured to perform a first image processing operation on the images. The first image processing operation may include applying a bricking (e.g., hierarchical bricking) to the low resolution images in which the images are chunked into smaller pieces, thereby generating a bricked dataset. In some embodiments, a set of processors 132 may be operatively coupled to each other in parallel to simultaneously process and/or analyze each chunk of the bricked dataset in parallel. In some embodiments, the processor(s) 132 can send at least a portion of the bricked dataset to the external device 190 via the communication network 120, and the computing system 130 and/or the external device 190 can process and/or analyze the bricked dataset in parallel. In some embodiments, the entire bricked dataset may be transmitted to the external device 190, and one or more processors associated with the external device 190 can process and/or analyze the bricked dataset in parallel.

The processor(s) 132 may be configured to apply one or more image processing steps to the low resolution images prior to and/or after the bricking. For example, the processor(s) 132 may perform flat fielding of the set of images to fix non-uniform illumination of the light sheet. In some embodiments, stitching may be performed to align an overlap of tiles within a channel (e.g., red, blue, green). In some embodiments, when greater than one channel is used, registration of the set of images may be performed to align overlap of channels. In some embodiments, autocropping may be performed in which a bounding box is computed to crop off saw-tooth edges and non-overlap. In some embodiments, fusion may be performed in which tiles of each channel are fused into a single image and the overlap is blended. In some embodiments, de-lining may be performed to remove lines from the set of images that occur due to oscillation of light sheet intensity. In some embodiments, depth correction can be performed to adjust for light attenuation with increased depth into the sample. In some embodiments, reslicing can be performed to reorient images to give a best default view of the images. In some embodiments, other processing steps can be performed such as merging in which channels are merged into a single image file (e.g., imagej file, tif file, etc.), file conversion to convert a file type to another file type (e.g. from jpg or png to avia.tif), and edge correction to remove excess stain and particulate from outside of the sample such as tissue sample.

In some embodiments, computational hematoxylin and eosin staining (H&E staining) can be performed in which image data may be converted from a two channel image file to a red, green, blue (RGB) image file, for example, by using Lambert Beer Law, to find a nuanced H&E coloring scale. In some embodiments, blank space detection may be performed to auto-shrink the bounding box if excess data was captured. In some embodiments, white-line fix may be performed to crop bright pixels (e.g., 2× brighter than average) from the top and the bottom of each tile from the image detector 112 (e.g., PCOS camera). In some embodiments, fix blank or black-line fixing may be performed to find and interpolate blank frames due to camera frame dropping. In some embodiments, an increase in speed of a virtual machine (VM) spin up may be performed by checking the dataset size and matching the VM to the specifications of the computer (e.g., the computing system 130). Performing VM spin up logic may save costs over using a default computer spin up. In some embodiments, any combination of the above image processing steps may be performed in any suitable order during the first image processing operation to generate optimized image data or at any other point during analysis of the image data. In some embodiments, all of the image processing steps are performed to generate optimized image data. In some embodiments, only a subset of the image processing steps are performed to generate optimized image data.

In some embodiments, the processor 132 may be configured to automatically select one or more ROIs within the low resolution image to re-image at high resolution, for example, using a trained ML or AI model. For example, in some embodiments, the first image processing operation may include detecting key features, computing characteristics associated with the detected key features (e.g., cancer content, immune cell density content, etc.), and automatically selecting ROIs based on the key features detected in the low resolution image data. In some embodiments, the first image processing operation may output spatial coordinates for one or more ROIs within the low resolution image data.

In some embodiments, the user may manually select the ROI within the low resolution image to re-image at high resolution. In some embodiments, the user may view a representation of the image data on the display 136 and use the interface 138 to define a position in spatial coordinates (in x, y, and z coordinates) of a feature of interest in the low resolution image. In some embodiments, the user may manually define a bounding box (in x, y, z coordinates) that defines the ROI. In some embodiments, the processor 132 may be configured to automatically define the bounding box for a feature of interest selected by the user. In some embodiments, the instructions executed by the processor may not allow an overlap of ROI bounding boxes.

At 153, the instructions 140 include steps which direct the controller 134 to control the imaging device 102 (e.g., the microscope) to select an objective (e.g., the high resolution objective). At 154, the instructions include steps which direct the controller 134 to control the imaging device 102 to capture high resolution images of the selected ROIs. In some embodiments, the user U may control the image device 102 via the interface 138 of the computing system 130 to capture one or more high resolution images of the one or more selected ROIs. In some embodiments, the processor 132 may be configured to transmit a signal to the controller 134 to control the imaging device 102 to capture one or more high resolution images of the one or more selected ROIs. For example, the processor 132 may send a signal indicative of the spatial coordinates of the ROI to the controller 134, and the controller 134 may relay the signal to the imaging device 102 to cause the actuator to move the high resolution objective to a predetermined position corresponding to the spatial coordinates. In some embodiments, the sample holder 108 may be moved such that the objective is aligned with a location or region corresponding to the spatial coordinates. In some embodiments, multiple selected ROIs can be imaged sequentially in high resolution.

In some embodiments, instructions 155 may include collecting a depth stack of the high resolution images. For example, the processor 132 may transmit a signal to the imaging device 102 configured to cause the imaging device 102 to capture high resolution images of the selected ROIs. The instructions 155 may include moving the sample to spatial coordinates associated with the ROI selected (e.g., a bounding edge of the bounding box). The instructions 155 may further include, capturing a first image from the detector 112 corresponding to the location defined by the ROI, moving the sample holder 108 a set distance (e.g., along a z-axis), capturing a second image, and so forth until a set number of images and/or a set distance along the z-axis that fall within the ROI has been achieved.

In some embodiments, the instructions 156 may include processing the depth stack of captured images 164 on a slice by slice basis to generate synthetic images based on the depth stack of the images and an ML or AI model. In some embodiments, the instructions 156 may include processing each slice along with one or more neighboring slices (e.g., adjacent slices). This may be useful given that the depth stack of captured images 164 represents a 3D volume of the sample 114, and structures may extend across multiple slices of the stack.

In some embodiments, once the depth stack of high resolution images is collected, a second image processing operation can be performed on the high resolution depth stack images. The second image processing operation may include any of the operations included in the first image processing operation. For example, the second image processing operation may include flat fielding the set of images, stitching the set of images, registration of the set of images, autocropping the set of images, fusion of the set of images, de-lining the set of images, depth correcting the set of images, reslicing the set of images, merging the set of images, edge correcting the set of images, converting file type of the set of images, detecting blank spaces in the set of images, using computational H&E, fixing white-lines, fixing blank-lines, fixing black-lines, and/or increasing a speed of VM spin up.

In some embodiments, the second image processing operation can include classifying pixels in the optimized image data into one or more classes, segmenting the optimized image data based on features of interest, quantifying the optimized image data, and correlating the optimized image data to quantify structures in the optimized image data corresponding to a medical indication. The instructions 150 include instructions 157 that describe segmenting features of interest based on the synthetic images. The memory 140 may include various segmentation criteria 166, which may be used to segment the synthetic images. For example, a brightness threshold may be used to generate a binary mask which in turn may be used to segment out the features of interest. The segmentation criteria 166 may be based on features of images collected using the second labelling technique (e.g., present in the synthetic images). In some embodiments, the segmentation may include using features in both the synthetic image and in the originally captured images. In some embodiments, the processer 132 may be instructed to transmit a signal indicative of the processed high resolution images. The processed high resolution images may be used for diagnosis, to determine treatment progress, to monitor disease progression, to predict future disease progression, etc. Instructions 150 include instructions 158 which describe training an ML model 162. In some embodiments the ML model can be trained to identify ROIs in the segmented images that may be indicative of a medical indication.

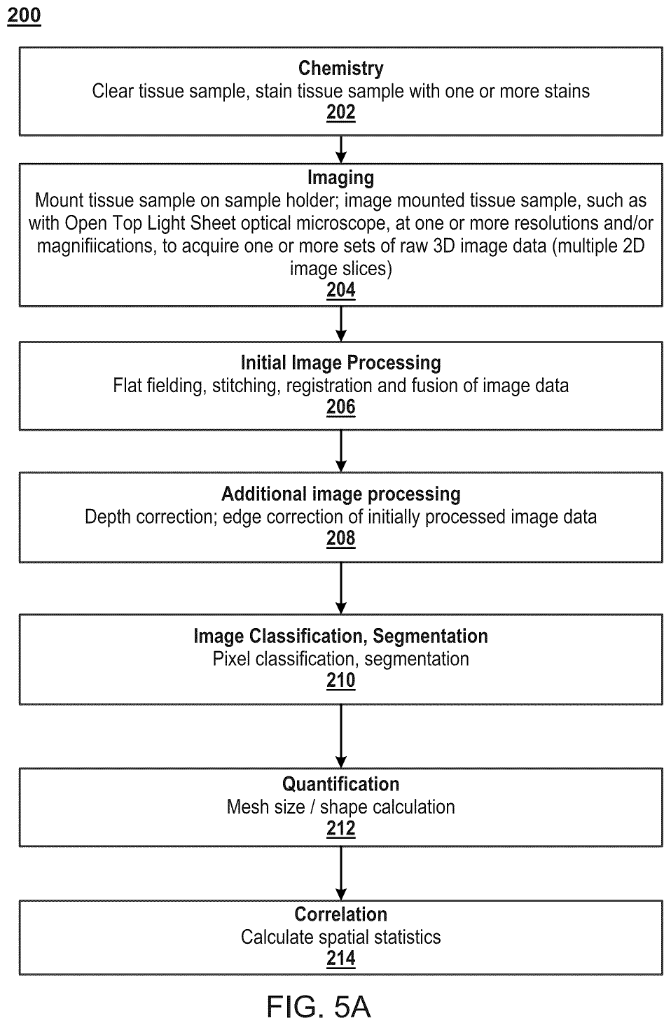

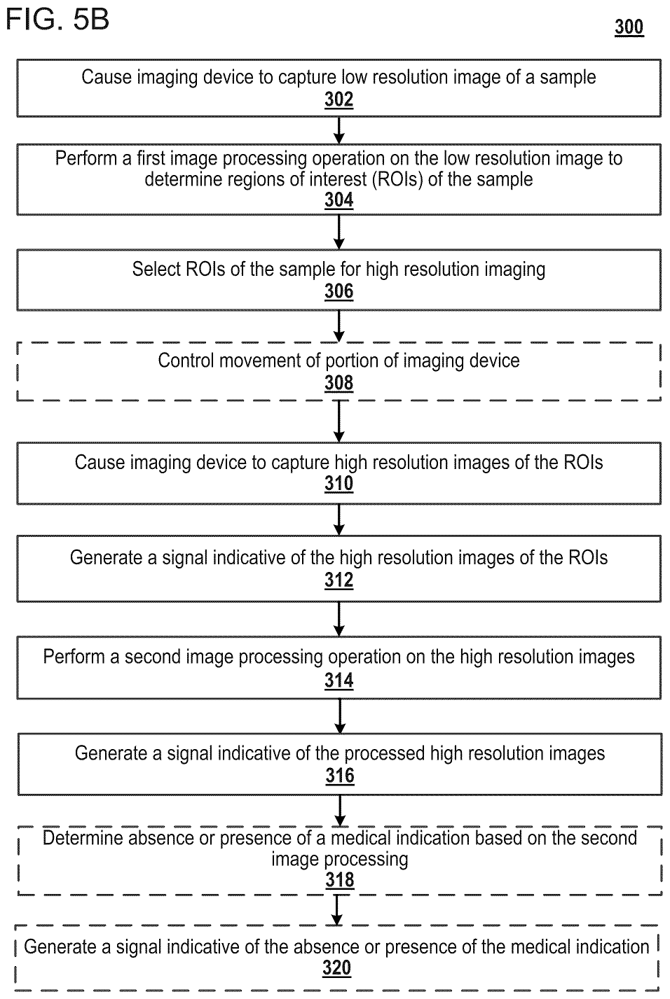

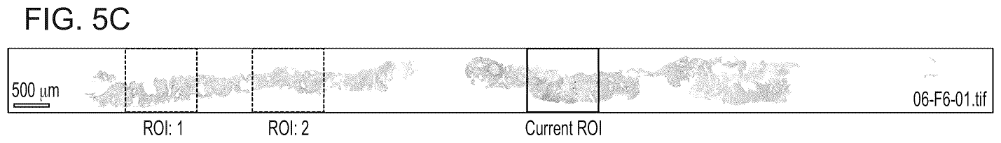

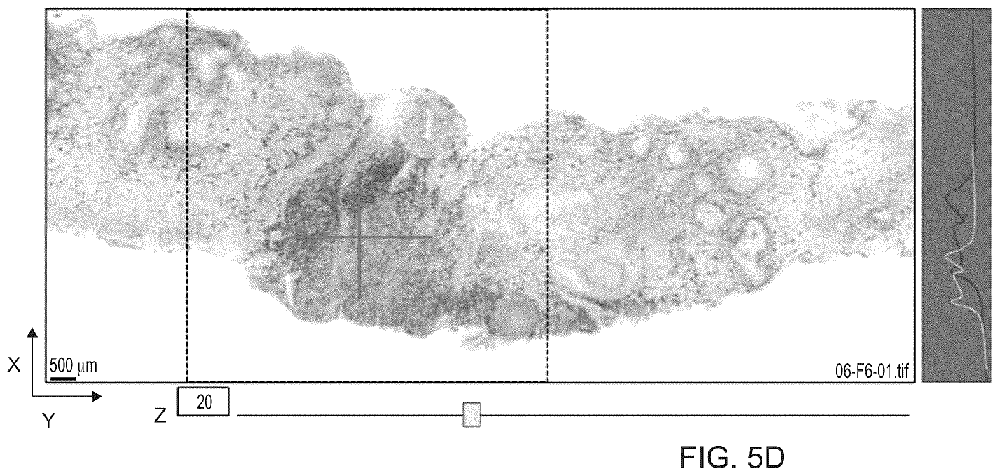

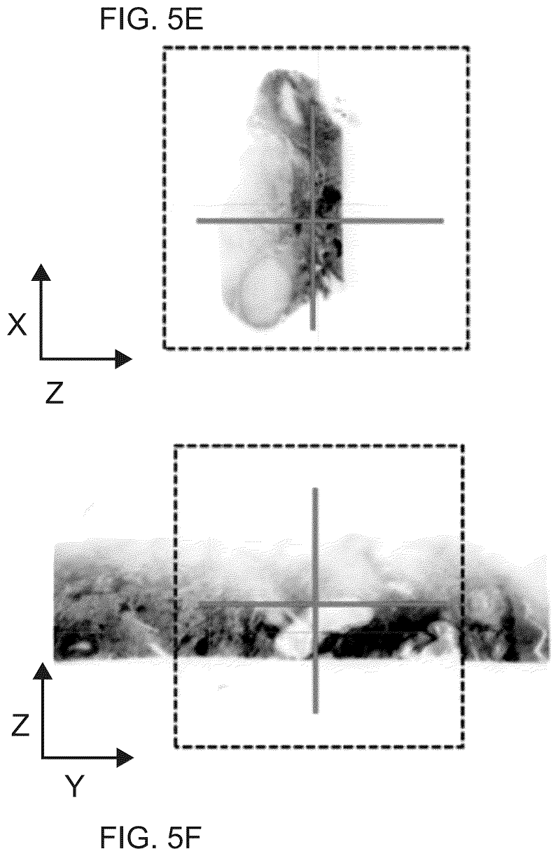

FIG. 5A illustrates a method of imaging a tissue sample and processing the image data using system 100, according to an embodiment. As shown in FIG. 5A, method 200 includes a series of steps or actions—many of these steps may be optional, the steps may be performed in sequences other than those shown in FIG. 5A, and other steps may be included. As shown, method 200 shows end to end sample preparation, imaging, data processing, and image analysis method according to an embodiment, which can also be referred to collectively as an imaging and analysis pipeline. At 202, chemistry can be applied to the tissue sample to prepare the sample for imaging at 204. This can include clearing the tissue sample, using known techniques and chemistries, such as iDISCO. Additionally, the tissue sample can be stained with one or more stains. For example, collagen (a primary component of fibrous structures, for example structures present in liver tissue with fibrosis) can be detected by staining the tissue with a suitable fluorophore-labeled collagen antigen that preferably accurately represents fibrosis in, for example, human liver tissues, such as the Collagen I antibody available from Novus Biologicals, a brand of Bio-Techne or the Collagen III antibody available from Abcam plc. A suitable Eosin stain can be applied to the tissue to enable differentiation of structures such as lipid droplets. In some embodiments, chemistry 204 is not required, for example when imaging green fluorescent protein (GFP), which has innate fluorescence and does not require staining with chemical labels.

At 204, the tissue sample can be imaged, as described in detail above, to acquire raw 3D image data. The tissue sample may be mounted on a sample holder, such as the sample holder 108 in optical system 100, or any of the sample holders disclosed in the '280 application. The mounted tissue sample can then be imaged, for example with an OTLS optical microscope such as the microscope shown in FIG. 1, or imaging device 102 shown in FIG. 4. Multiple 2D images slices, such as those shown in FIG. 2, can be acquired. Optionally, the tissue sample can be imaged at more than one magnification and/or more than one resolution, using different optical components and/or capabilities of the microscope system, generating more than one set of 2D image data. More than one set of 2D image data can be acquired, for example one set of image data may be based on a first labelling technique that is not specifically targeted to a tissue structure of interest (for example a general stain such as an H&E analog), and second set of image data may be based on a labeling technique that is targeted to a biomarker associated with tissue structure of interest (such as collagen, for fibrous tissue).

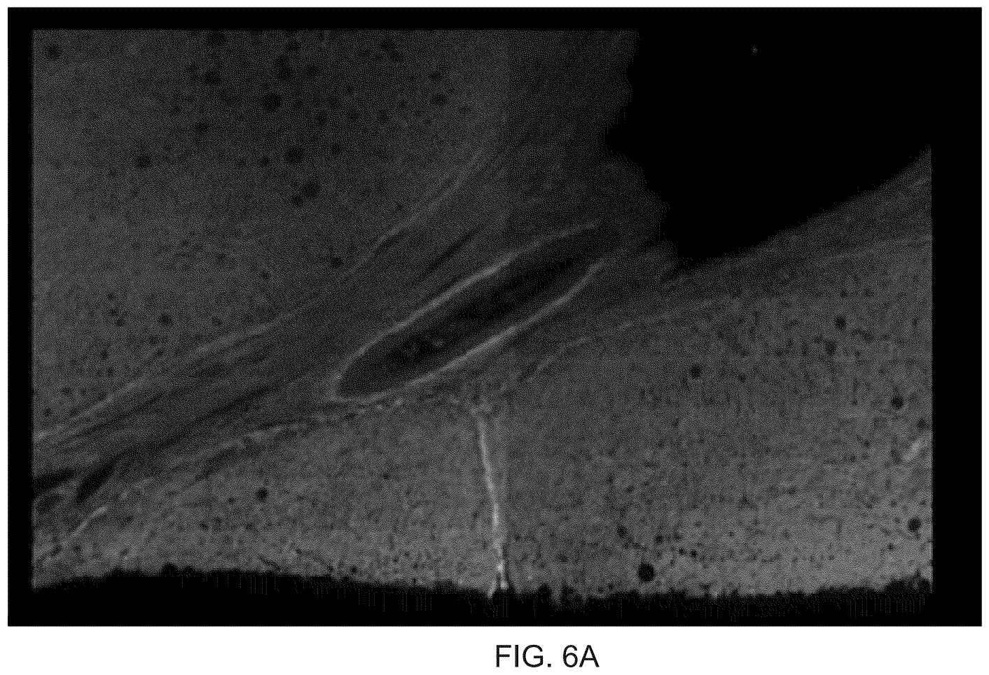

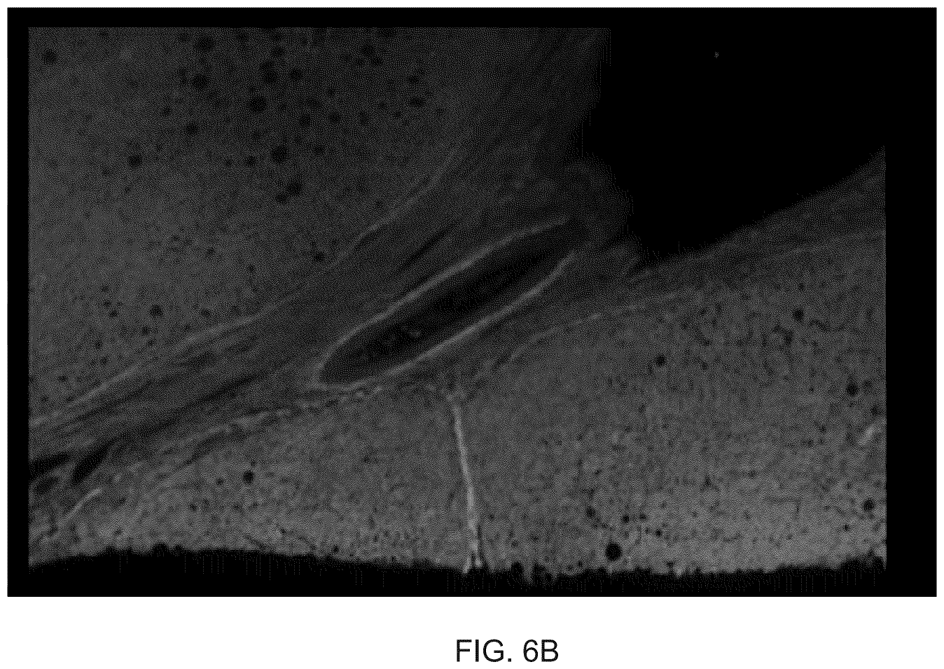

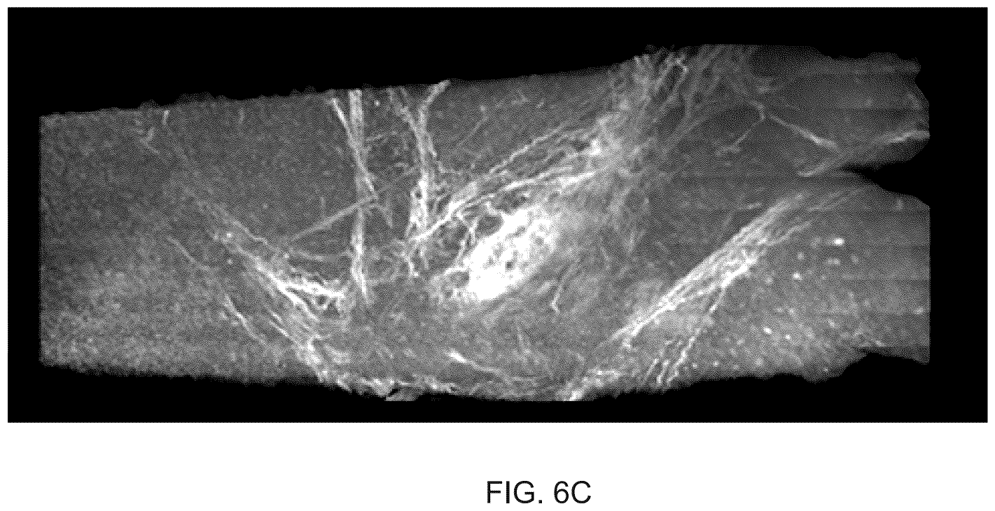

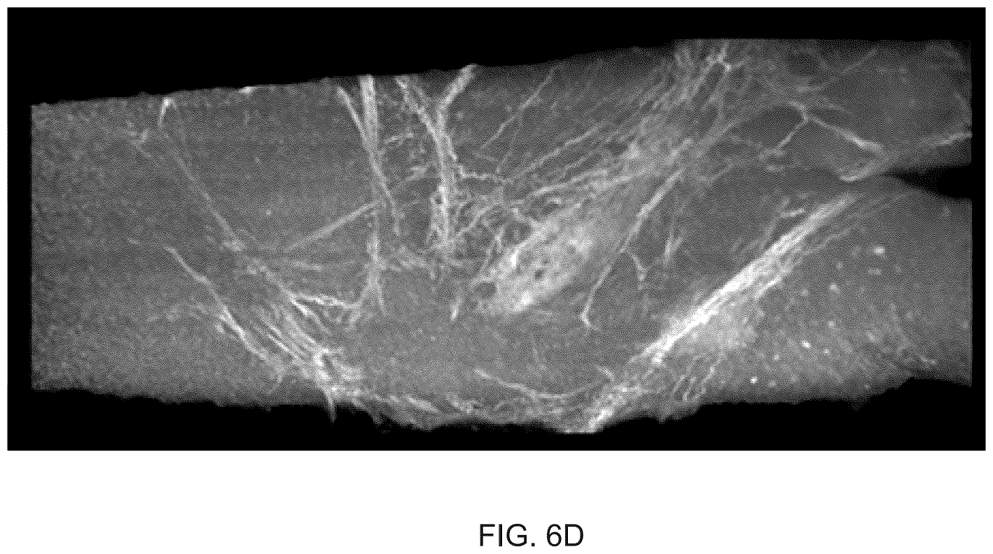

At 206, the raw image data from 204 can be initially processed to optimize the resultant data for downstream analysis using computational methods. For example, each of the one or more sets of 2D images slices can be flat fielded (as described in more detail below with reference to FIGS. 6A to 6D) to normalize pixel intensity across the left-right or horizontal axis of the image. The 2D images can also be stitched (using standard stitching approaches) to combine multiple 2D image slices with overlapping fields of view to produce a larger composite image. The 2D images can also be registered (optionally augmenting computational registration with manual correction to improve results) by transforming different sets of data into one coordinate system such as pixel intensity data from different wavelengths imaged over the sample. Each of the foregoing steps can be performed in any order. Then, multiple image data sets can then be fused (preferably with no down-sampling) to combine all of the important information from multiple images and the inclusion into fewer images, usually a single composite image.

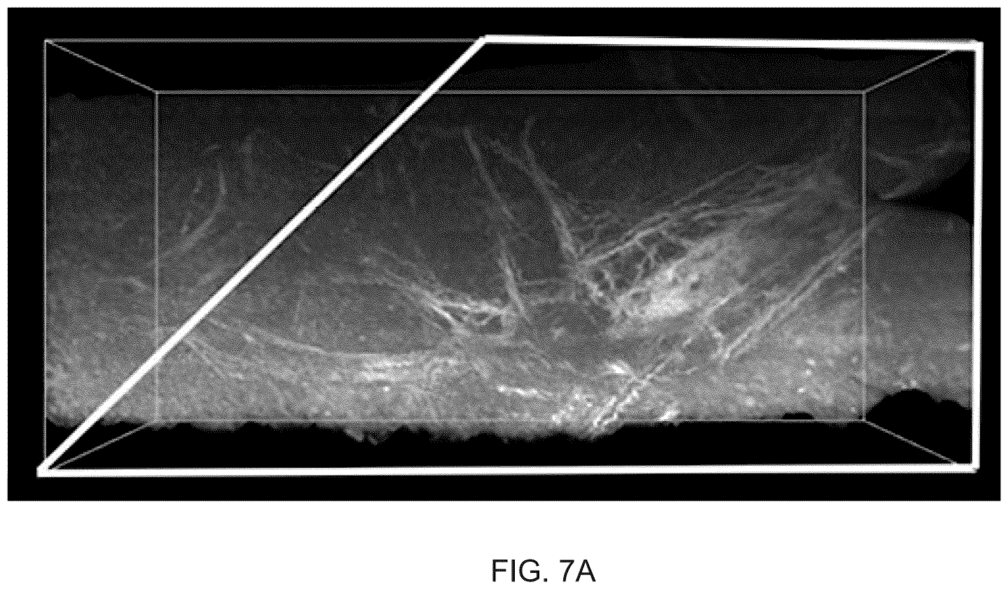

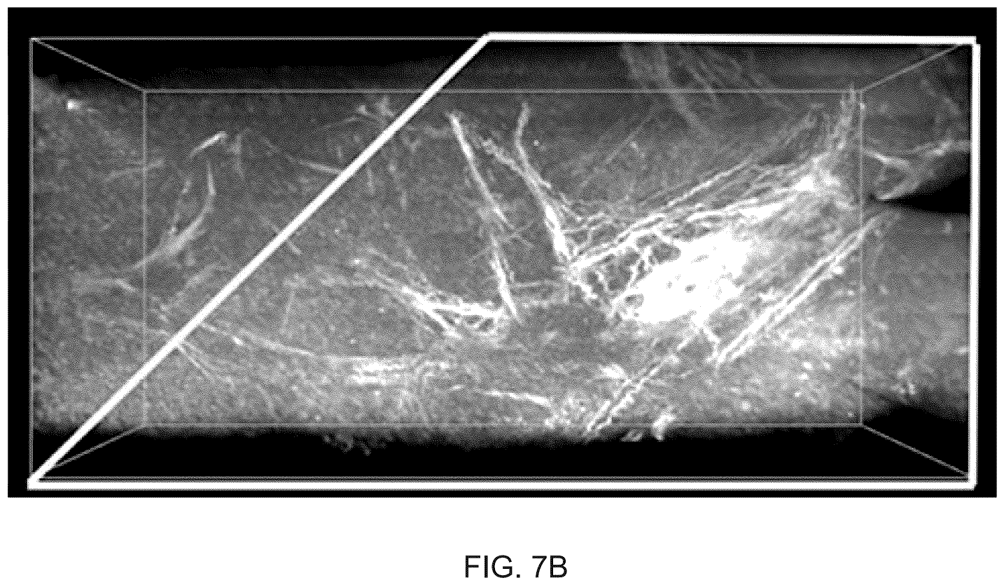

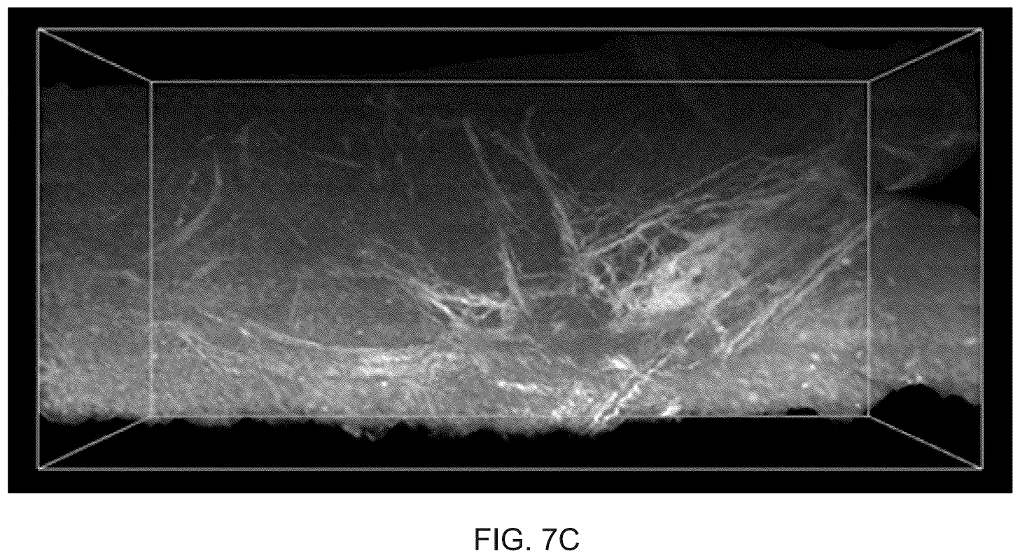

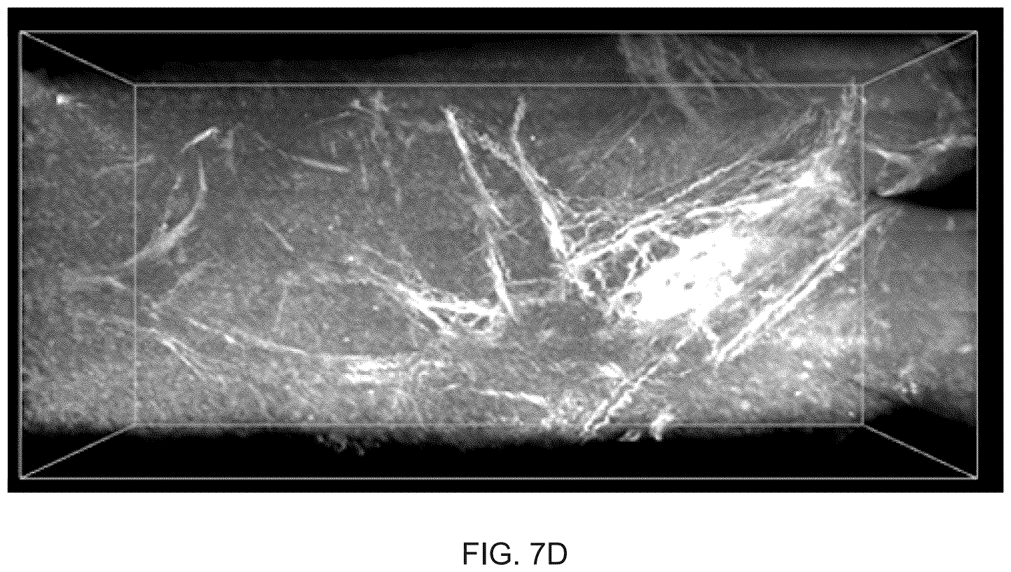

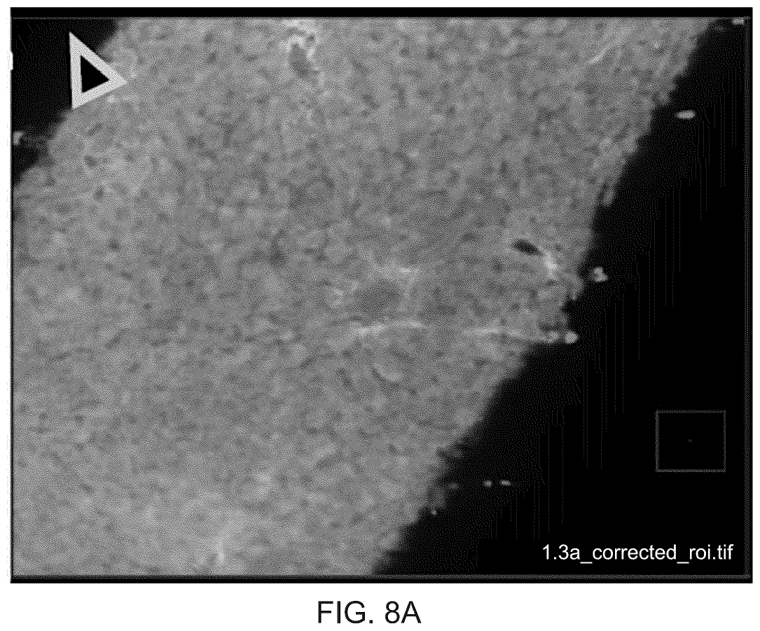

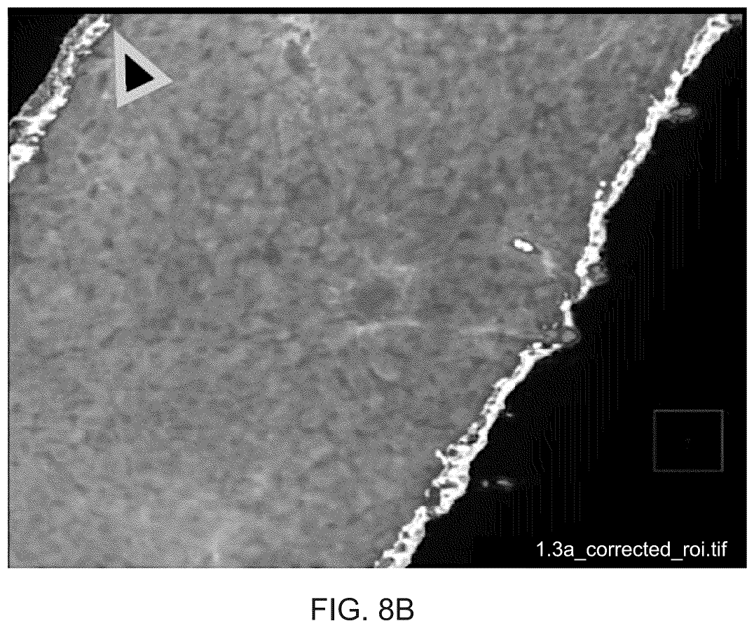

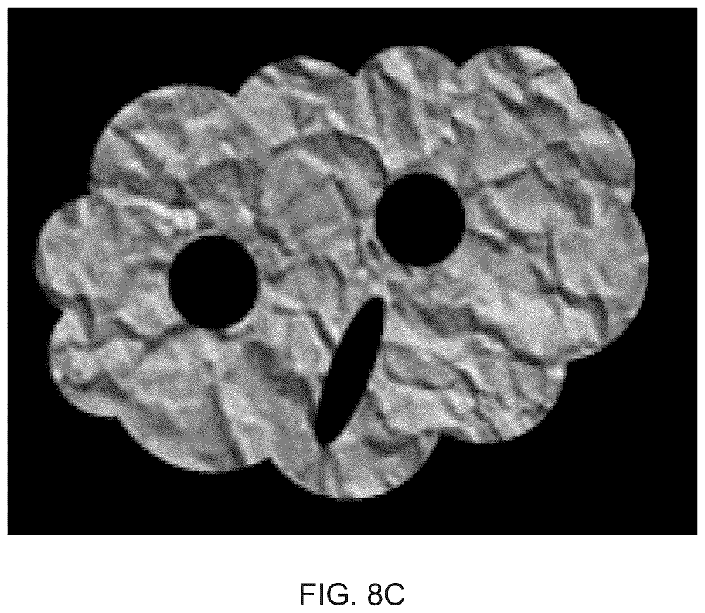

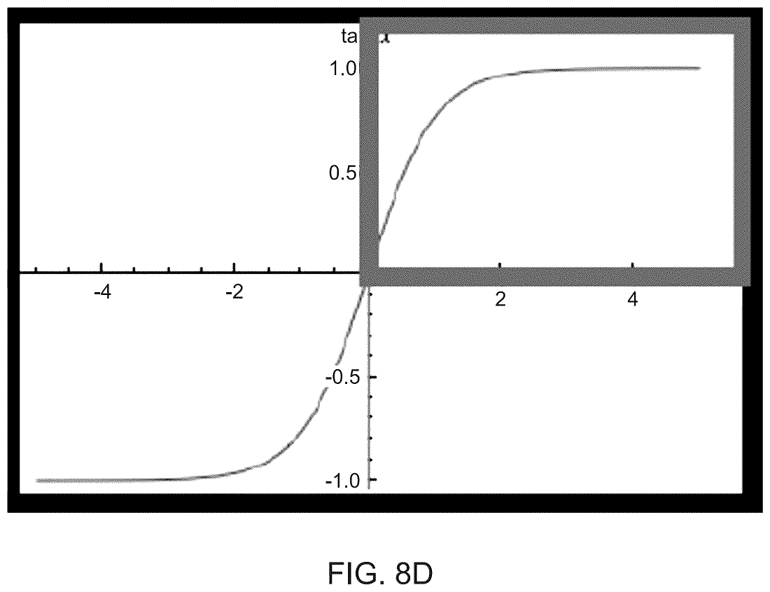

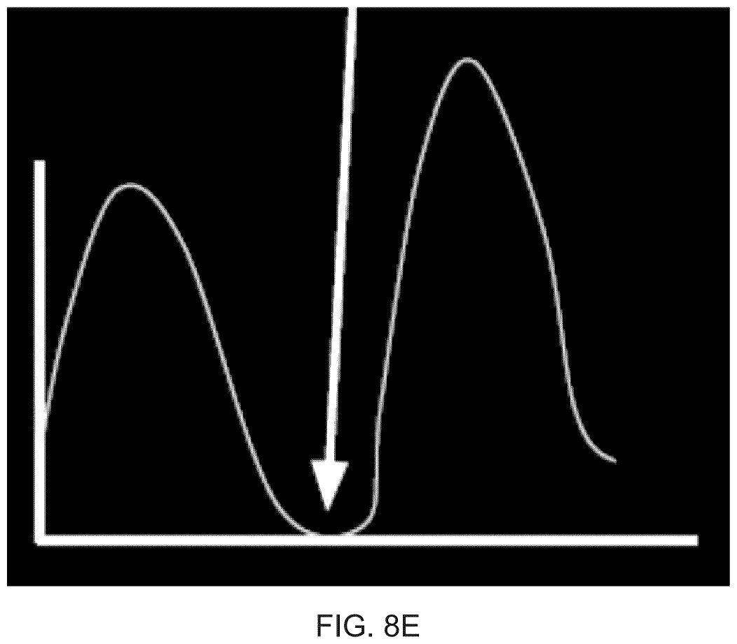

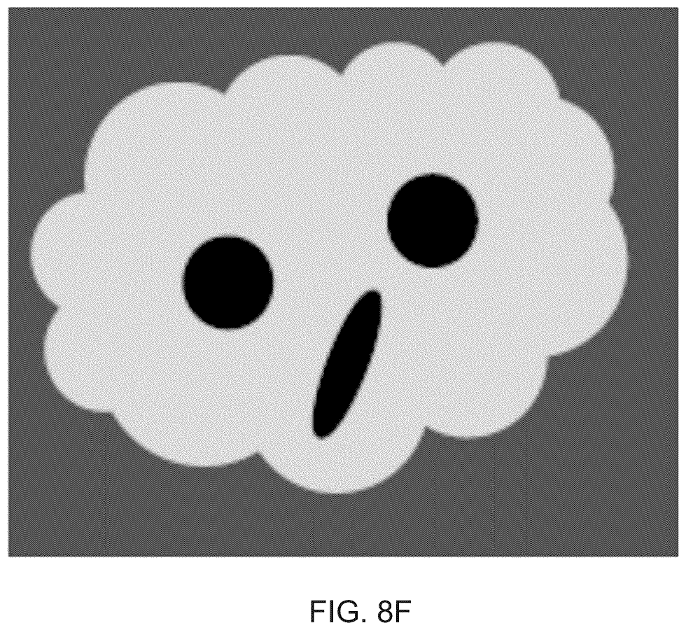

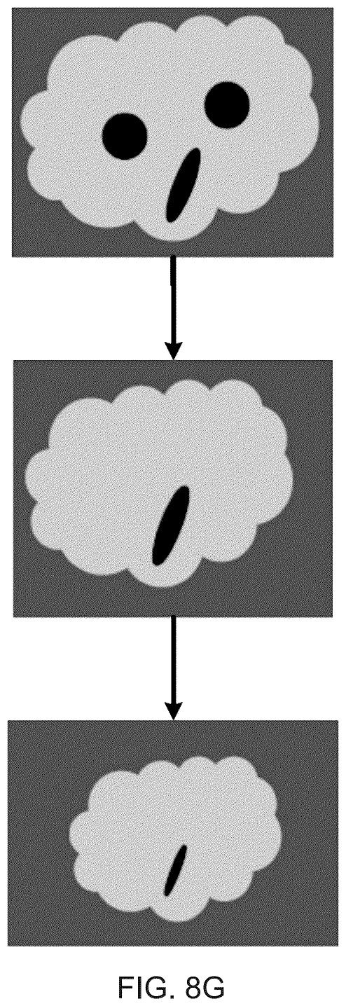

At 208, the initially processed image data can be additionally processed by applying depth correction (as described in more detail below with reference to FIGS. 7A to 7D) to account for the leveling off of pixel intensity as the image depth in a sample increases, and edge correction (as described in more detail below with reference to FIGS. 8A to 8G) to remove non-specific or non-biological signal and other imaging artifacts on the periphery of the sample. These additional process steps can be performed in any order.

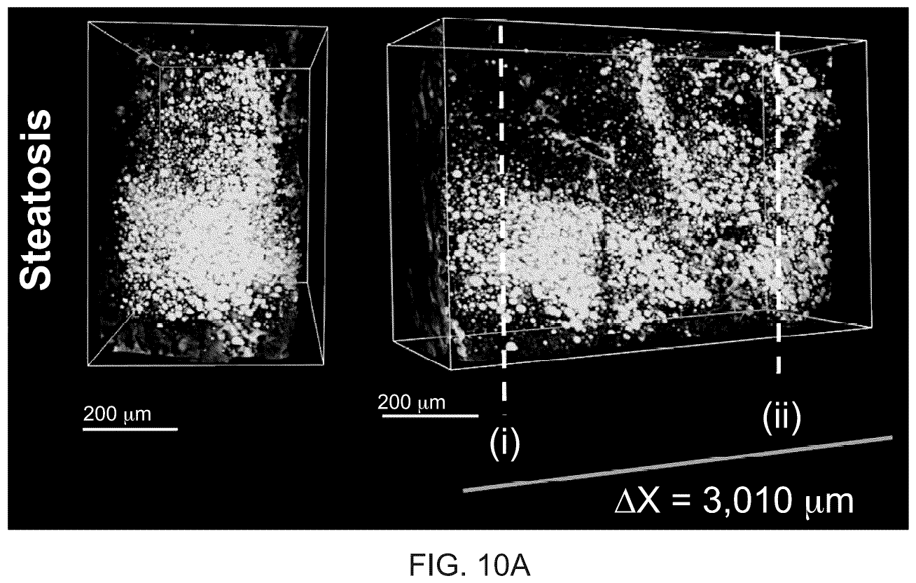

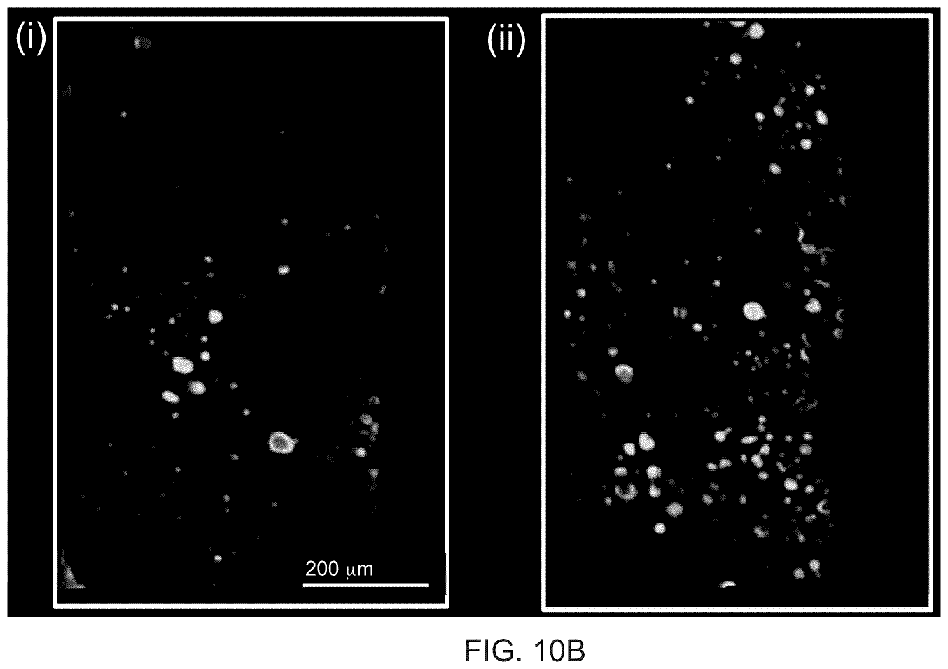

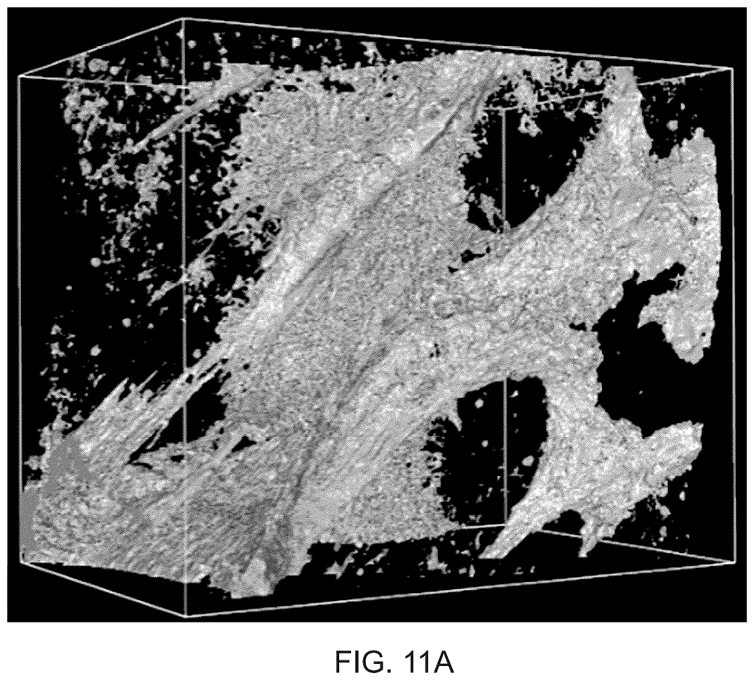

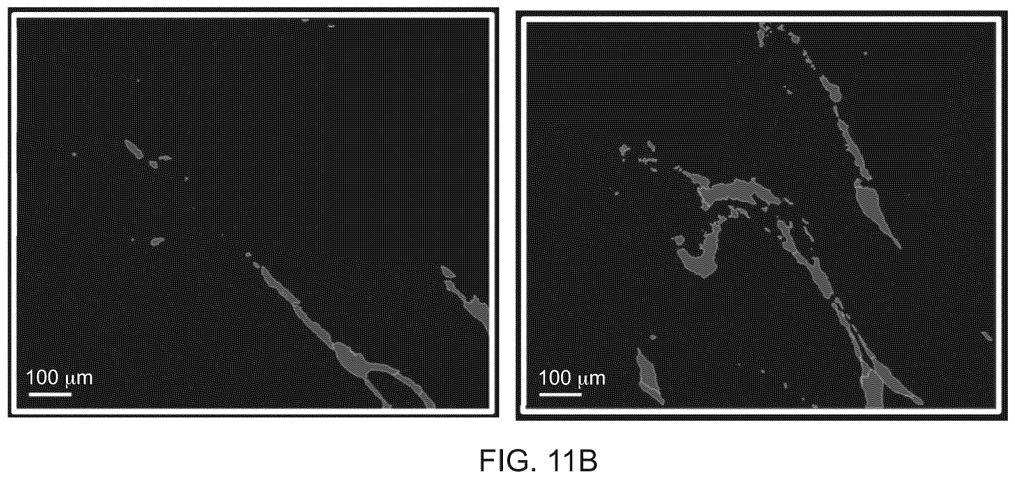

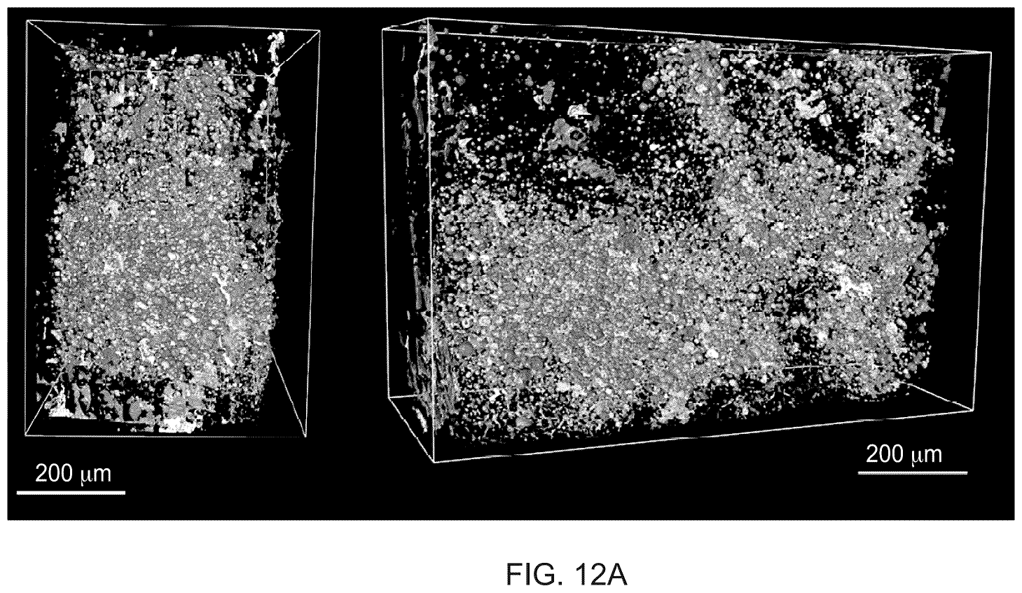

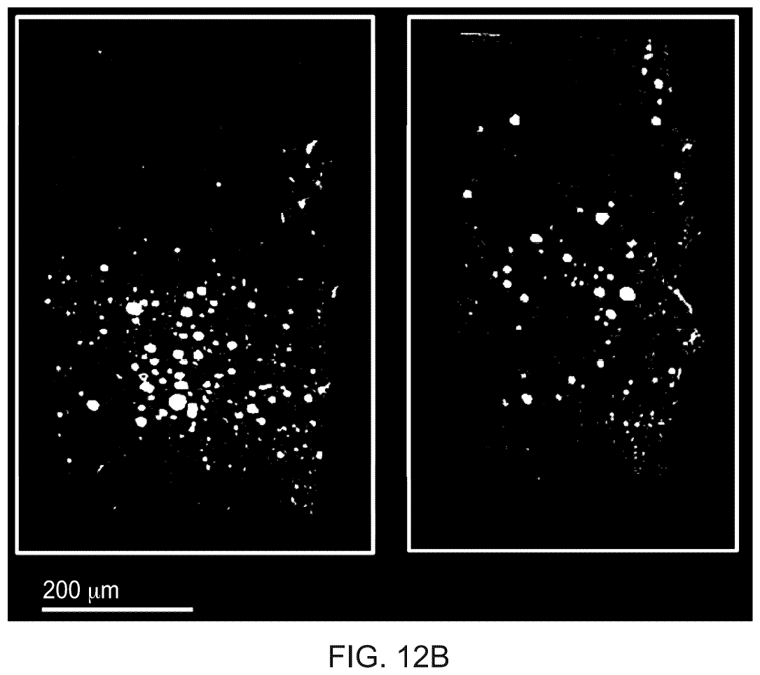

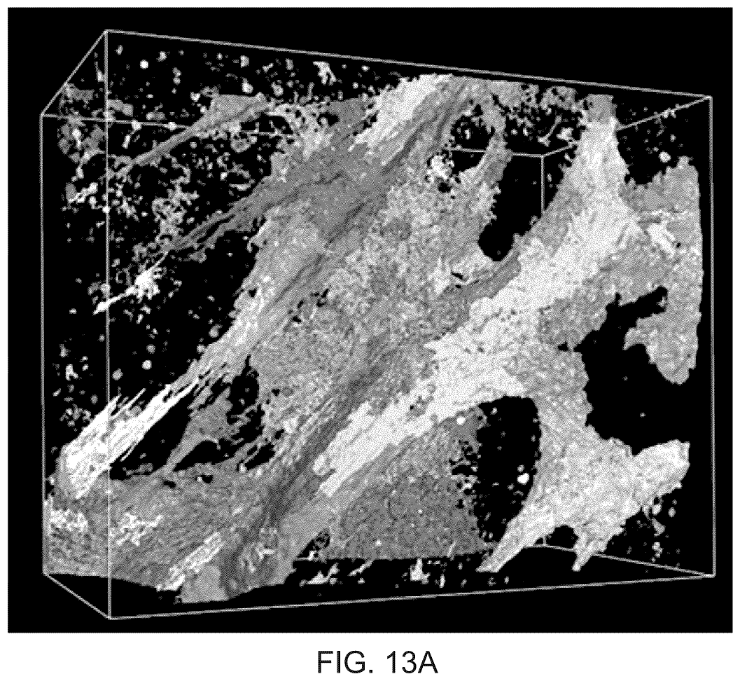

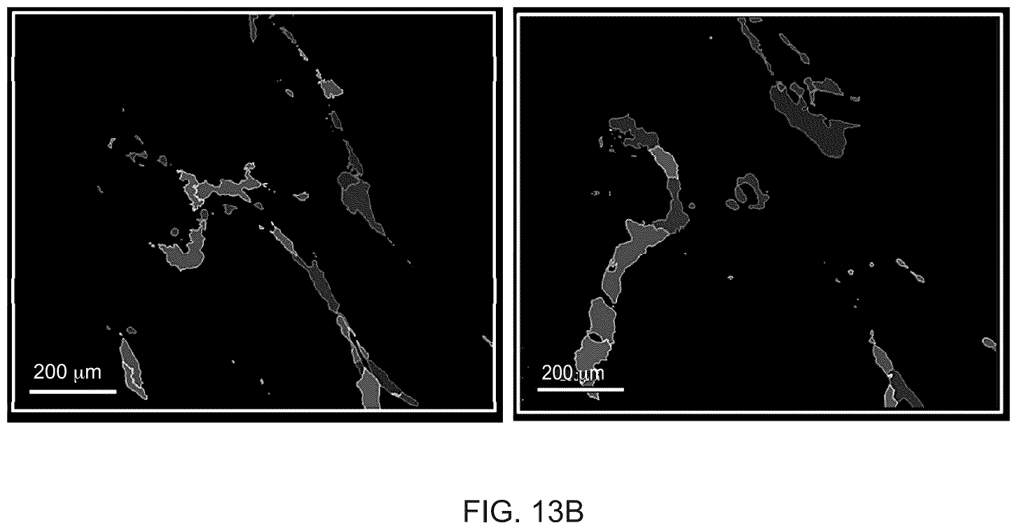

At 210, pixels in the image data can be classified, as described in more detail below with reference to FIGS. 10A and 10B and FIGS. 11A and 11B, to identify pixels in the resultant image as belonging to one or more classes. The image data can then be segmented for structures of interest according to features such as distribution, density, intensity, or other features, as described in more detail below with reference to FIGS. 12A and 12B and FIGS. 13A and 13B.

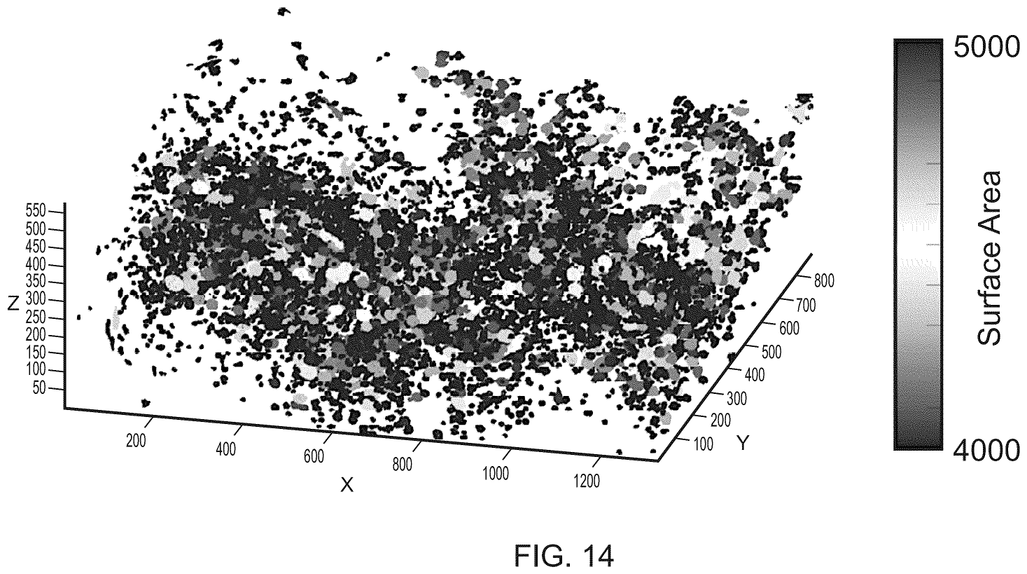

At 212, the image data can be quantified, with mesh size/shape calculation, as described in more detail below with reference to FIG. 14.

Finally, at 214, the image data can be correlated, i.e., spatial statistics can be calculated to identify spatial relationships, such as distances between objects, correlations between spatial positions, and organization and randomness of feature positions. These spatial statistics can be used, for example, for quantification of fibrosis and steatosis in liver tissue.

FIG. 5B illustrates a method 300 of imaging a sample and processing the image data using the system 100, according to an embodiment. While described with the imaging device 102 and the computing system 130 included in the system 100, it should be appreciated that the operations of the method 300 can be performed using any other suitable imaging device and computing system. All such implementations are contemplated and should be considered to be within the scope of the present application.

At 302, the imaging device 102 may be instructed to capture one or more low resolution images of the sample (e.g., a tissue sample). In some embodiments, the user U may manually trigger the imaging device 102 to capture low resolution image(s) of the sample via the interface 138 of the computing system 130. In some embodiments, the user U may set one or more imaging parameters (e.g., brightness, contrast, etc.) to optimize the images captured.

A first image processing operation is performed on the low resolution image(s) to determine regions of interest (ROIs) of the sample, at 304. In some embodiments, the computing system 130 may receive the low resolution image(s) and perform the first imaging processing operation locally. In some embodiments, the system 100 may be configured to employ bricking such that a set of processors can process the low resolution image(s) in parallel to reduce an amount of time for processing the image(s). For example, a set of processors in the computing system 130 may be configured to process the bricked data set in parallel. In some embodiments, the computing system 130 may be configured to send the bricked dataset of the low resolution image(s) to the external device 190 via the communication network 120 such that the computing system 130 and the external device 190 may process and/or analyze the low resolution images in parallel. In some embodiments, the computing system 103 may send the full bricked dataset to the external device 190 including a set of processors, and the set of processors of the external device 190 may process and/or analyze the low resolution images in parallel. The first imaging processing operation includes additional steps that may be executed including flat fielding the set of images, stitching the set of images, registration of the set of images, autocropping the set of images, fusion of the set of images, de-lining the set of images, depth correcting the set of images, reslicing the set of images, merging the set of images, edge correcting the set of images, converting file type of the set of images, detecting blank spaces in the set of images, using computational H&E, fixing white-lines, fixing blank-lines, fixing black-lines, and/or increasing a speed of VM spin up.

At 306, ROIs of the sample are selected for high resolution imaging. In some embodiments, the user U may manually select ROIs based on features identified in the low resolution images. For example, the user U may select coordinates of a relevant feature (e.g., abnormal cells indicating cancer content, immune cell density content, etc.). In some embodiments, the user U may define a bounding box, or a region surrounding the coordinates of the relevant feature. In some embodiments, the ROIs may be selected by the system 100 autonomously. For example, the computing system 130 and/or the external device 190 may execute code or an algorithm (e.g., a ML model, a deep learning algorithm, a convolution neural network) that automatically detects relevant features, automatically defines the bounding box for the ROI, and selects relevant ROIs (e.g., the algorithm may select a subset of important ROIs) for high resolution imaging. In some embodiments, the low resolution data set may be stored in the memory 140 on the computing system 130 or a database external to the computing system 130, such as the database 192 of the external device 190.

At 308, the method 300 may optionally include controlling movement of a portion of the imaging device 102. For example, an actuator controlling placement of a sample holder holding the sample may be controlled to move the sample holder (in x, y, and/or z direction) to coordinates corresponding to the selected ROIs such that the high resolution objective is aligned to image the coordinates of the selected ROIs. In some embodiments, the computing system 130 may automatically and/or autonomously trigger the imaging device 102 to move the portion of the imaging device 102. In some embodiments, the user U may control movement of the portion of the imaging device (e.g., using the display 136 and the interface 138 of the computing system 130 or manually moving the high resolution objective into position for capturing the high resolution images).

At 310, the imaging device is caused to capture high resolution images of the ROIs. In some embodiments, the computing system 130 may automatically and/or autonomously trigger the imaging device 102 to begin collecting high resolution images of the ROIs. For example, the computing system 130 may include or be in communication with a trained ML or AI model configured to analyze the low resolution image to determine the regions of interest, and then cause the imaging device 102 to capture images of selected ROIs. In some embodiments, the user U may trigger the imaging device 102 (e.g., using the display 136 and the interface 138 of the computing system 130) to capture high resolution images of the ROIs. At 312, the imaging device 102 generates a signal indicative of the high resolution images of the ROIs. For example, the sensor of the CMOS camera generates a signal, and the signal is transmitted to the processor 132 of the computing system 130. In some embodiments, the signal may be transmitted via the communication network 120. In some embodiments, the signal may be transmitted through a wire connected directly to the computing system 130. In some embodiments, the signal may be transmitted to the external device 190 via the communication network 120. In some embodiments, the computing system 130 may be configured to additionally, or alternatively, generate the signal indicative of the high resolution images, which may be configured to be communicate to the external device 190 for storage or further processing.

At 314, a second image processing operation is performed on the high resolution images. In some embodiments, the computing system 130 may receive the high resolution image(s) and perform the second imaging processing operation locally. In some embodiments, the computing system 130 may be configured to employ bricking such that a set of processors can process the high resolution image(s) in parallel to reduce an amount of time for processing the image(s). In some embodiments, the second image processing operation may be performed on the external device 190. For example, the computing system 130 may be configured to send raw high resolution image dataset, or the bricked dataset of the high resolution image(s) to the external device 190 via the communication network 120 such that the computing system 130 and/or the external device 190 may process and/or analyze the high resolution images in parallel. In some embodiments, the computing system 103 may send the entire bricked dataset to the external device 190 including a set of processors, and the set of processors of the external device 190 may process and/or analyze the high resolution images in parallel. The second imaging processing operation includes additional steps that may be executed including flat fielding the set of images, stitching the set of images, registration of the set of images, autocropping the set of images, fusion of the set of images, de-lining the set of images, depth correcting the set of images, reslicing the set of images, merging the set of images, edge correcting the set of images, converting file type of the set of images, detecting blank spaces in the set of images, using computational H&E, fixing white-lines, fixing blank-lines, fixing black-lines, and/or increasing a speed of VM spin up, as previously described herein.

At 316, a signal is generated indicative of the processed high resolution images. The signal may be stored on the memory 140 of the computing system 130, or on a database external to the computing system such as the database 192 of the external device 190. In some embodiments, the processed high resolution data set may include a processed 3D image stack of the sample. In some embodiments, the signal may be configured to display the processed high resolution images on the display 136. The processed high resolution images may include color to distinguish or highlight areas of interest within the high resolution images, quantify parameters corresponding to a medical indication, indicative size or areas of various regions, and/or include other indicators that may facilitate a user in predicting a medical condition based on the processed high resolution images. In some embodiments, the processed high resolution data set may include a visual representation of the data (e.g., a processed 3D image stack of the sample including markers indicating detected features and/or flagged structures). In some embodiments, the processed high resolution data set may include results indicating coordinates for features and/or structures detected. For example, the processed high resolution data set may include a data file (e.g., CSV file, .json file, .mat file, .txt file, etc.) including coordinates corresponding to the detected features and/or flagged structures.

The method 300 may optionally include determining an absence or presence of a medical indication based on the second image processing, at 318. In some embodiments, the high resolution imaging data may be analyzed for the presence of abnormal features. In some embodiments, the processed high resolution data set may be analyzed manually by the user U and/or one or more third party users. For example, the user U and/or one or more third party users (e.g., pathologist, physician, researcher, etc.) may assess the processed 3D image stack of the sample and/or any coordinates output by the second image processing operation. In some embodiments, the computing system 130 and/or the external device 190 may execute an algorithm to analyze the output from the second image processing operation to determine an absence of presence of a medical indication. The method 300 may optionally include generating a signal indicative of the absence or the presence of the medical indication at 320 (e.g., communicated to the external system 190, or configured to cause information associated with the absence or presence of the medical indication on the display 136).

FIGS. 5C to 5F show an interactive interface showing images of biological samples for selection of ROIs, according to an embodiment. In some embodiments, the display of the computing system and/or an external device may be configured to display a visual representation of the images captured by the imaging device. In some embodiments, the computing system may display low resolution images captured such that the user may select one or more ROIs via inputs to the interface. Expanding further, FIG. 5C shows a low resolution image of a biopsy tissue sample captured by a low resolution objective of an imaging device. The low resolution image includes many empty areas that do not include the tissue and other areas that are not of interest in determining a medical indication from the biopsy sample. As shown in FIG. 5C, the user has selected a first and a second ROI on a first biopsy and is in the process of selecting an ROI on a second biopsy sample. For the first biopsy sample, a first bounding box has been generated around the first ROI and displayed, and a second bounding box has been generated around the second ROI and displayed.

As shown in FIG. 5D, a portion of a 2D slice of the second biopsy sample along the z-axis is displayed to the user. The computing system may be configured to allow a user to manipulate the representation of the image including to zoom in or out, to scroll or pan (using a cursor of the interface) through the image of the sample in an x direction, y direction, and/or z direction to view different portions of the sample, and/or to adjust a stain intensity (e.g., of eosin and/or nuclear channels). In some embodiments, the user may adjust a gamma of the image. The user may use a scroll bar to move through each 2D slice of the tissue sample. The user may then manually select (e.g., using the interface) a location on the 2D slice corresponding to a feature of interest (e.g., abnormal tissue structure). The location selected represents the x, y, and z coordinates of a centroid of an ROI. In some embodiments, a visual marker (e.g., a crosshair) may be displayed to demarcate the coordinates of the location selected. In some embodiments, the user may define a bounding box that defines a region around the centroid having a predetermined distance in the x, y, and z directions from the centroid. In some embodiments, the predetermined distance may be in a range of about 0.2 mm to about 3 mm inclusive all values and subranges therebetween. In some embodiments, the predetermined distance may be 1 mm. In some embodiments, the predetermined distance in the x direction, y direction, and z direction may be the same. In some embodiments, the predetermined distance in at least one of the x direction, y direction, and z direction may be different. In some embodiments, the processor may execute instructions that may automatically define the bounding box. In some embodiments, the bounding box may include the entire field of view of the biopsy in the x direction and the z direction, as shown in FIG. 5D. In some embodiments, the instructions may not allow an overlap between the bounding boxes of ROIs. In some embodiments, the user may have the option to reselect the ROI (e.g., the user may drag the crosshairs to a different location) and/or to save the ROI defined. In some embodiments, the interface may be configured such that the user can record notes regarding the biological sample such as notes relating to tissue structure, quality of imaging, reasons for choosing ROIs, etc. In some embodiments, the data collected during ROI selection is saved as a metadata file (e.g., a .csv file, a .json file, etc.) including the centroid coordinates, the scan bounds in x, y, and z direction, the notes, and the time taken to select the ROI.

Different views of the biopsy sample may be displayed while selecting ROIs. For example, FIG. 5E shows the second biopsy sample on a Z-X axis, whereas FIG. 5F shows the second biopsy sample on the Y-Z axis. Viewing the biopsy sample using different axes can aid the user in identifying features and determining optimal ROI positioning. While the ROI in FIGS. 5C and 5D are described as being selected by a user, in some embodiments, a trained ML or Ai model may additionally, or alternatively, be used to determine and/or select the ROIs.

FIGS. 6A to 6D illustrate flat fielding to address image artifacts arising from uneven laser intensity distribution across the field of view of the detector 114. Uncorrected image data is shown in FIGS. 6A and 6C. Each reflects the effect of uneven laser intensity distribution, leading to signal intensity drop off at the edges of the single 2D images—when the full 3D data are generated, this leads to dim “lines” through the data set. For example, in FIG. 6A, the image data are uneven from left to right, with a clear seam from top to bottom between the 2D frames. Similarly, in FIG. 6C, the image data are uneven from top to bottom, with a clear seam from left to right between frames. This undesired effect can be corrected by multiplying each 2D image by the inverse of the laser intensity drop off across the field of view. This can be done either algorithmically, or using a reference calibration “flat field” image. In an algorithmic approach, for each 2D image a hyperbolic tangent approach to thresholding can be used to ensure that each pixel is part of the 2D image, then the mean signal intensity value across the image is determined. This mean intensity value is then used to correct each 2D image slice so that all fields of view of the detector (camera) 114 have even signal. This approach eliminates the visible boundaries (seams or lines) between the frames. The results can be seen in FIG. 6B (produced by application of this algorithm to FIG. 6A) and FIG. 6D (produced by application of this algorithm to FIG. 6C).

As noted above, after the initial image processing (206 in FIG. 5A), additional image processing (208 in FIG. 5A) can be performed. For example, depth correction may be applied to the image data. The signal intensity at each pixel varies with the depth of each pixel into the tissue from the source of the illumination light of the OTLS microscope, because the illumination light intensity attenuates in the tissue in direct proportion to the depth, according to the Beer-Lambert Law:

A=εlc

Where A=the absorbance, ε is the molar attenuation coefficient or absorptivity of the attenuating species or material, l is the optical path length (in cm), and c is the concentration of the attenuating species or material. To correct for this effect, the product of coefficients ε and c can be determined empirically for each tissue of interest and for different disease states for each tissue, by measuring signal intensity degradation as a function of measured or calculated depth for a known illumination intensity. Depth correction coefficients can then be obtained for each tissue and for each disease state for the tissue, and applied to the acquired image data. The concentration c of scattering or absorbing components can be different in every tissue sample. Thus, the model sets new coefficients for each new piece of tissue on the microscope. However, rather than processing all of the pixels (potentially in the billions), which can be computationally intensive, a Monte Carlo approach can be used to randomly sample a relatively small subset of pixels (i.e., down sample), such as about 100,000, to calculate the coefficients for each tissue sample, and those coefficients are applied to all of the pixels.

In some OTLS microscope geometries, such as the one shown in FIG. 1, and in embodiments disclosed in the '656 patent, a principle optical axis of the illumination path of the illumination light of the OTLS microscope may be at an angle (e.g., 45 degrees) to the plane of the tissue sample holder—this angle is taken into account in the depth calculation.

As shown in FIG. 7A, different portions of the 3D image data set can be processed differently. In the upper left corner of the image (outside of the yellow boundary), the amount of tissue cannot be measured, so the depth of each pixel in the tissue is estimated. In the rest of the image (inside of the yellow boundary), the depth of each pixel can be calculated exactly because the full path of the laser to reach that pixel has been imaged. The depth correction model is fitted to the tissue within the yellow boundary, and then applied to the whole tissue (the entire 3D image data set). As can be seen in FIG. 7A, the image is darker at the top, and brighter at the bottom. Application of the depth correction to image in FIG. 7A results in the image in FIG. 7B, which is more uniform in brightness. Similarly, FIG. 7D is a depth-corrected version of FIG. 7C.

As noted above, additional image processing (208 in FIG. 5A), in addition to depth correction can include (either before or after) edge correction. When antibody-based stains are applied to a tissue sample, the edges of tissue can accumulate excess antibody, which leads to nonspecific staining. This edge effect can include the walls of lumens (such as blood vessels) in the tissue. The usefulness of image data can be improved by excluding the edge of tissue from, and preserving the inside of vessels or other biological “holes” in the tissue in, the data set before subsequent steps (e.g., segmentation and quantification, described below) are performed. The edge effect is illustrated in FIGS. 8A and 8B. The bright red pixel groups at the edges of the tissue in FIG. 8A are staining artifacts. When a pixel classifier is run on the image data, it may use sharp jumps from tissue to background signal as a feature that causes the boundary of the tissue to be included in the classification (.e.g. for fibrosis and/or steatosis)—this yields the bright yellow edges in the image.

In accordance with one embodiment, these edge effects can be addressed as follows. First, one structural staining channel (e.g., an Eosin channel) is used to calculate a binary mask and crop the image, as shown in FIG. 8C. The hyperbolic tangent (tanh) of the ratio of the signal for each pixel to the mean signal for all pixels in the image is calculated to tighten the spread of pixel values in the foreground, as shown in FIG. 8D. The values are plotted on a histogram, and a Gaussian filter is applied to smooth until there are two peaks. The minimum between the two peaks is found, and used to calculate a threshold value, as shown in FIG. 8E. A binary mask array of the image is then generated with this threshold value, as shown in FIG. 8F. As shown in FIG. 8G, mathematical morphology operators are used to fill in the holes and vessels inside the tissue to prevent them from being cropped out. Binary erosion is then applied to remove the pixels near the edges of the mask. The resulting mask can then be applied to the image, which is then exported to the pixel classifier to train it. This correction reduces misclassification along the edges of the tissue, as shown in FIGS. 8A and 8B.

### Analysis of Specific Tissue Types

The 3D microscopy of tissue specimens and subsequent analysis of those images described here yields large amounts of high-resolution micro-scale structural information, which can be used for biological discoveries or many varying clinical assays. The method of imaging and quantifying tissue structures such as vessels or glands in order to extract quantitative “features” (geometric parameters) can be predictive of disease aggressiveness (i.e. prognosis) or predictive of response to specific forms of therapy for any disease or therapy that affects the organization and morphology of these features. The 3D microscopy of tissue specimens and subsequent analysis of those images described here yields large amounts of high-resolution micro-scale structural information, which can be used for biological discoveries or many varying clinical assays. The method of imaging and quantifying tissue structures such as vessels or glands in order to extract quantitative “features” (geometric parameters) can be predictive of disease aggressiveness (i.e. prognosis) or predictive of response to specific forms of therapy for any disease or therapy that affects the organization and morphology of these features. The methods of analysis described herein refer to a specific tissue example of liver but can be applied more generally to other tissue types and disease states. In particular, extracting features such as fibrosis and steatosis can apply to other tissue types like lung, skin, and other tissues in human, animal, and synthetic (i.e. lab grown tissues like organoids or spheroids) models, for example. These analysis methods are based on geometric features contained within the morphology of a given sample and are not limited based on tissue type or disease state and therefore the methods described are applicable more generally than in the specific liver use case described below.

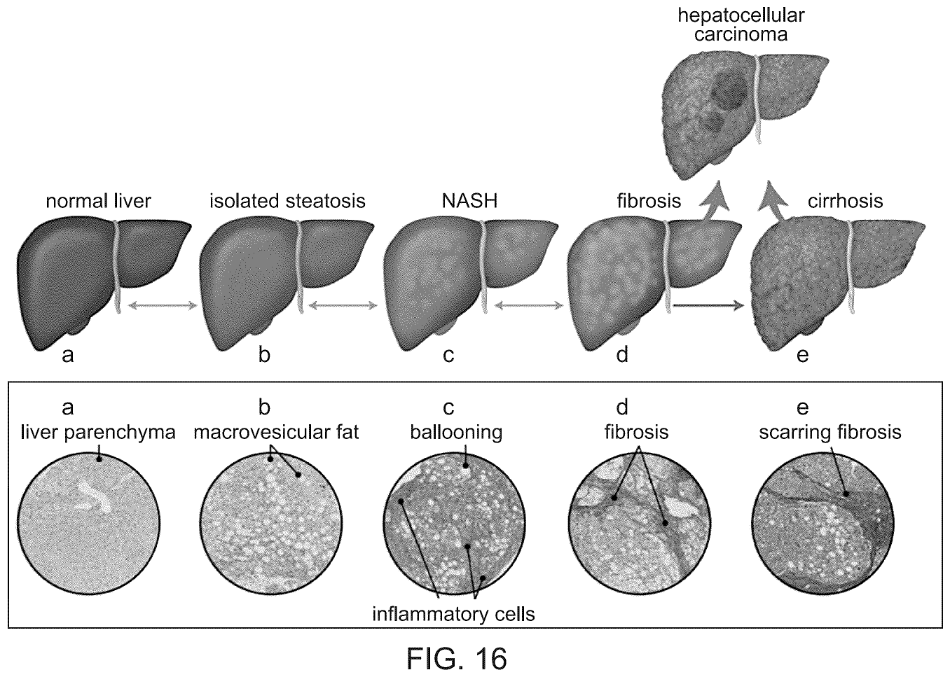

As discussed above, liver fibrosis is a hallmark feature of all chronic liver diseases. Non-alcoholic fatty liver disease (NALFD) is the most common cause of liver disease globally. Nonalcoholic steatohepatitis (NASH) is an inflammatory subset of NALFD characterized by steatosis, inflammation, and hepatocyte ballooning. Roughly one third of NASH patients will progress to cirrhosis with high risk for hepatocellular carcinoma and mortality (See FIG. 16). NAFLD is forecasted to increase in prevalence from 83.1 million cases in 2015 to 100.9 million cases in 2030. No pharmacological therapies are currently available. Thus, early and accurate diagnosis is imperative. Also, there are numerous promising drug candidates being evaluated in clinical trials. There are no accurate clinically utilized non-invasive tests to determine the presence of steatohepatitis, and limitations exist on standard radiological evaluation of fibrosis. The primary outcome used in these clinical trials to determine drug efficacy is therefore the histologic assessment of fibrosis via liver biopsy using traditional pathology—this remains the “gold standard” for the assessment of fibrosis, e.g., for identifying steatohepatitis and its progression in clinical cases. Traditional methods suffer from significant under sampling, in that about 1% of the sample is evaluated. These methods also suffer from interpretative errors, in the use of a subjective five category scale to determine fibrosis stage (i.e., Batts and Ludwig) in an attempt to quantify a continuous variable. Sample preparation and image processing according to embodiments disclosed herein enable imaging of the entire liver biopsy sample and evaluation of the severity of liver damage based on the quantity and distribution of fibrosis and steatosis. Further diagnostic variability can be introduced if inflammation and hepatocyte ballooning is present in the tissue. The imaging process techniques described below can address these shortcomings.

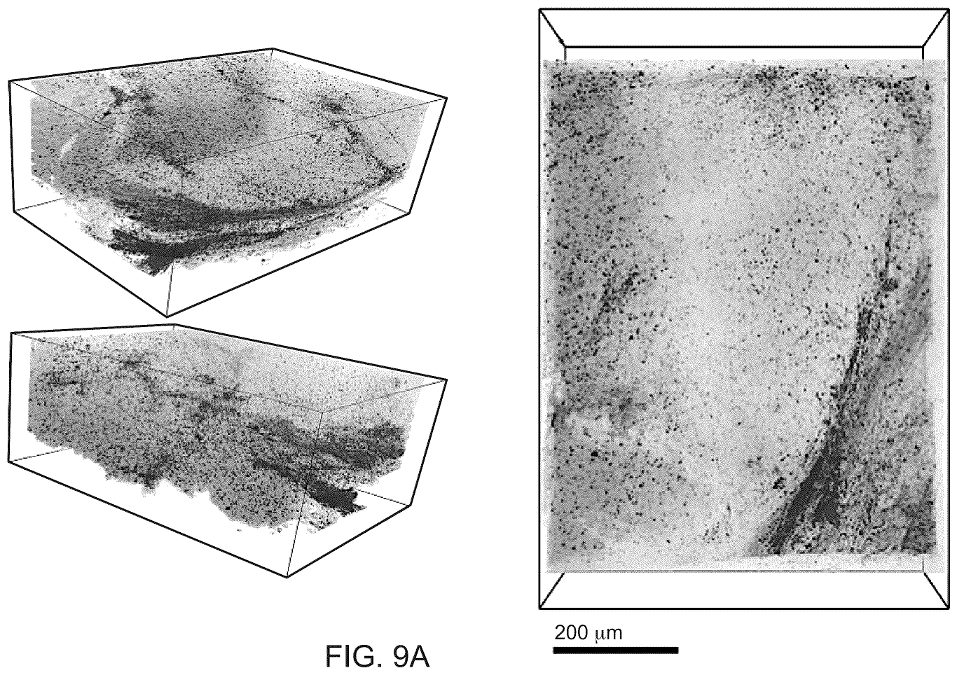

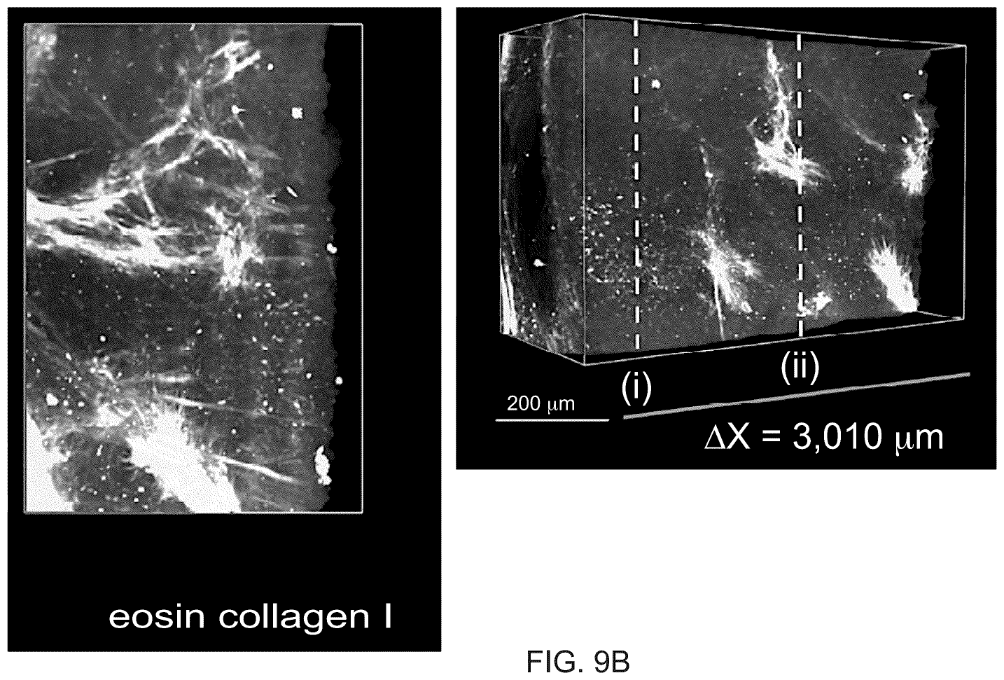

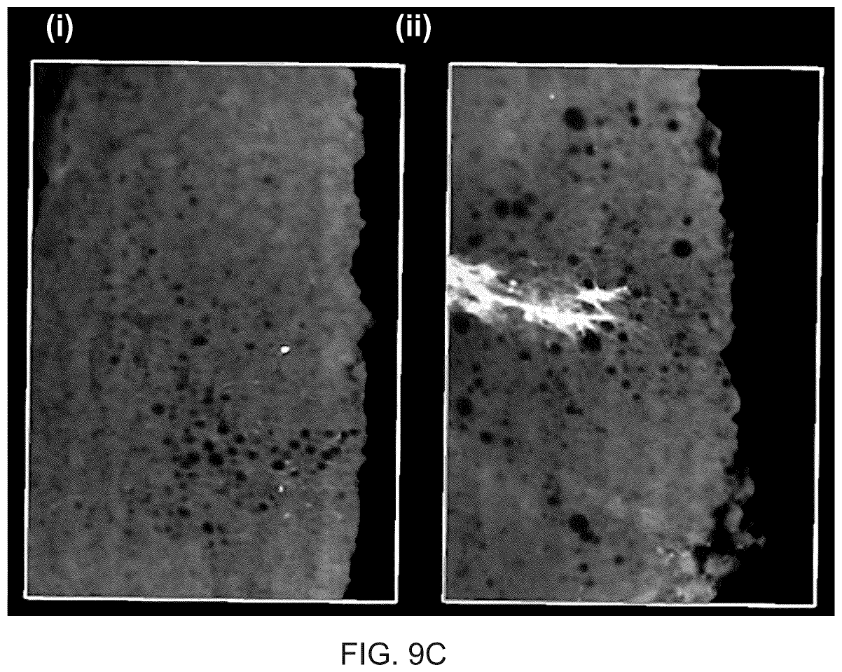

In one example, a tissue sample from a liver biopsy from a human subject can be processed, for example, in accordance with the method 200 described above. More specifically, the sample can be fixed in formalin, then optically cleared using iDISCO. Advantageously, the sample can be stained with Collagen I (Novus) or Collagen III (Abcam) antibodies (as identified above), and Eosin. A region of the biopsy tissue sample roughly 1 mm³ in volume can be imaged with an OTLS microscope system, such as system 100 described above. 3D image data sets can be acquired as described above. Example raw image data are shown in FIGS. 9A (H&E), 9B (3D immunofluorescence) and 9C (2D immunofluorescence, showing sections (i) and (ii) from FIG. 9B).

As noted above, at 210 (FIG. 5A), a pixel classification process can then be conducted on the image data, using, for example, the Aivia AI image analysis software available from Leica Microsystems. The classification process can be similar to that disclosed in the incorporated '096 application, and the disclosed techniques can also be used to generate synthetic images based on an ML model (such as 162 in FIG. 4) and to train the ML model (as in 158 in FIG. 4). The user can annotate pixels in the image data in which the user has a high confidence in the classification (e.g., lipid, collagen) of the pixel. In a training mode, a wide array of tissues that sample all the potential biology (and/or represent biological heterogeneity) that could be present in tissues on which the classifier will be used can be annotated by the user. The classifier can be run to generate a new image, or channel, with a new image with confidence in the classifier. The new channel can be inspected by the user to identify problems causing noise or misclassification, such as: a) antibody deposition on the edges of tissue; b) cracks or breaks in the tissue; c) poor staining or low signal areas; d) poor clearing and blurry areas; e) poor registration between Eosin and collagen channels; f) poorly mounted samples that moved during imaging; g) rare biological features such as tumors; and h) sharp jumps from tissue to background that may be recognized as a feature by the pixel classifier that causes the boundary (tissue edge or vessels) to be included in the classification in that may have to be thresholded or cropped at the segmentation level. Once the confidence channel is working correctly, then the image can be segmented with confidence with a threshold-based approach (as described below).

For example, 3D and 2D computational channels for steatosis (based on lipid classified pixels) are shown in FIGS. 10A and 10B, respectively—FIG. 10B shows sections (i) and (ii) from FIG. 10A. Similarly, 3D and 2D computational channels for fibrosis (based on collagen classified pixels) are shown in FIGS. 11A and 11B, respectively—FIG. 11B shows sections from FIG. 11A.

As noted above, after pixel classification, the computational channels can be processed to segment (210 in FIG. 5A) for lipid droplets or steatosis (identified by round hypodense areas) and collagen fibers, generating 2D and 3D meshes using, for example, a threshold-based approach. A random forest algorithm can be used to identify pixels that belong to fat droplets or fibrosis with some level of confidence according to a probability distribution. The desired confidence threshold will depend on the accuracy of the pixel classifier. The resulting image is a computationally-generated image (not a measurement-based image). Each pixel value is a probability that the pixel is fat or fibrosis, rather than a physical measurement of fluorescence intensity. Pixels above a specified confidence level can be assigned to a fat droplet or fibrous band using, for example, the watershed function in Aivia. This technique can be applied to any object within the tissue sample, not just for steatosis or fibrosis, such as specific cell types (immune cells, epithelial cells), or other structures (vessels, bile ducts, etc.).

For steatosis, the meshes are preferably independent, but some level of partitioning of the meshes can be used to split touching lipid droplets. Large meshes as the edges of the tissue sample arising from the feature error in pixel classifier confidence can be thresholded out. For example, 3D and 2D meshes of steatosis are shown in FIGS. 12A and 12B, respectively. The image in FIG. 12A includes different colors to represent the degree of confidence that the group of pixels are part of a unique fat droplet (in contrast to FIGS. 10A and 10B, which is a computational representation of pixels that are assigned as belong to fat droplets).

Similarly, for fibrosis, partitioning can be used to split large fibrotic bands into smaller portions or chunks, which can reduce or eliminate noise in subsequent processing steps. For example, 3D and 2D meshes of fibrosis are shown in FIGS. 13A and 13B, respectively. The images in FIGS. 13A and 13B include different colors to represent the degree of confidence that the group of pixels are part of a unique fiber structure (in contrast to FIGS. 11A and 11B, which is a computational representation of pixels that are assigned as belong to fiber structures).

As noted above, after mesh objects are generated from the segmentation process described above (210 in FIG. 5A), calculated measurements can be made to quantify, or calculate physical properties, such as volume, sphericity, surface area, position in 3D space, and mean intensity (212 in FIG. 5A). These measurements can be based on full shape metrics, rather than being a point-based analysis. For example, the radius, volume, and clustering of lipid droplets, the degree of fibrosis, and their spatial relationship with surrounding liver parenchyma, can be localized and quantified. Liquid droplets can also be categorized into large, intermediate, and small sizes. For example, FIG. 14 shows the distribution of surface area of lipid droplets in the tissue sample, based on additional data cleaning to gate out noise based on parameters such as non-spherical (probably not a droplet). The shape of the tissue sample can also be calculated to enable calculation of accurate volume percentages for each component of the tissue (steatosis, fibrosis). Two or more physical properties can be plotted to identify subsets of segmented objects that correspond to artifact, disease states, microanatomy, etc. Similar processes can be used to measure conicity, curvature, branching, tortuosity, isoparametric deficit, fractal dimension, etc.

As noted above, at 214 (FIG. 5A), correlation can be performed to calculate spatial characteristics. Objects can be clustered using k means of clustering or self-organizing neural networks to identify subsets of objects that are similar to each other. Regression can be used to correlate physical properties and spatial relationships with binary or survival outcomes. The co-occurrence of, for example, steatosis, fibrosis, or other segmented objects can be correlated by x, y, z coordinates. Physical properties and spatial relationships can be correlated with molecular data (such as sequencing of RNA, DNA, and/or proteomics). Spatial relationships of segmented objects can be compared to randomly distributed points to detect whether there is a spatial clustering of the objects.

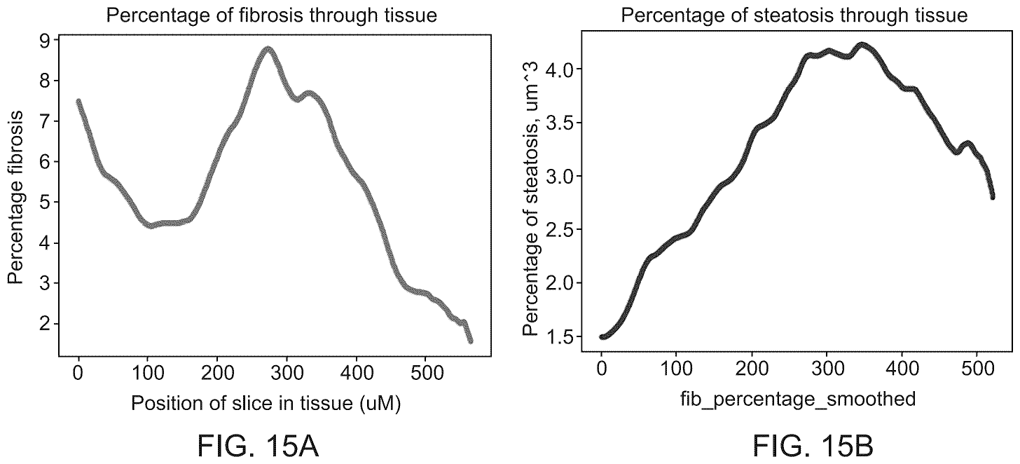

The superiority of the imaging processing techniques described above for 3D image data acquired, for example, by an OTLS microscope, over the current 2D histological techniques is illustrated in FIGS. 15A and 15B. FIG. 15A shows the percentage of fibrosis as a function of the position of the image slice in the tissue based on computational channels such as those shown in FIGS. 11A and 11B and meshes such as those shown in FIGS. 13A and 13B. Similarly, FIG. 15B shows the percentage of steatosis as a function of position in the image slice of tissue based on computational channels such as those shown in FIGS. 10A and 10B, and meshes such as those shown in FIGS. 12A and 12B. It is apparent from FIGS. 15A and 15B that the 3D distribution of steatosis and fibrosis varied substantially throughout the volume of the tissue sample. This illustrates the under sampling problem with current histological techniques—depending on the location of the physical tissue slice taken for the 2D histological analysis, very different percentages of fibrosis and/or steatosis may be calculated, leading to inaccurate or non-representative determination of disease state.

The systems and methods described herein may be used to generate a 3D image database of prostate biopsies, analyze the prostate biopsy data, and train and validate algorithms configured to be executed by the system 100 or any other system described herein for automated ROI selection. In some embodiments, prostate biopsies from a plurality of patients can be imaged and a predetermined number of ROIs (e.g., 3, 4, 5, etc.) may be selected manually from each biopsy to create training and validation data for automation of ROI selection. In some embodiments, ROIs may define a cube with a volume between about 0.5 mm³ to about 3 mm³. In some embodiments, the cube has a volume of about 1 mm³. Ex vivo prostate biopsies can be prepared from fresh prostatectomy specimens. For the purpose of training the model, the prostate biopsies may target regions at which the original pathology report indicated carcinoma was present to maximize chances for detecting carcinoma. The biopsies can be cleared and stained with nuclear (TOPRO3) and cytoplasmic (eosin) fluorescent dyes using previously described methods. The cleared and stained biopsies can be rapidly imaged with the system in low resolution. The coordinates for the ROIs (e.g., 3 ROIs with volume 1 mm³) can be selected from pathologist examination of the low resolution image, and the coordinates may be reimaged in high resolution. The ROIs may be ranked in terms of importance in contributing to the diagnosis or cancer grade. Subsequently, the biopsies can be histologically processed and digitized hematoxylin and eosin (H&E) slides can be prepared. Relevant clinical information including pathology report parameters, PSA, and demographic information alongside the 3D image datasets may be stored in a secure, de-identified, and encrypted server (e.g., the external device).

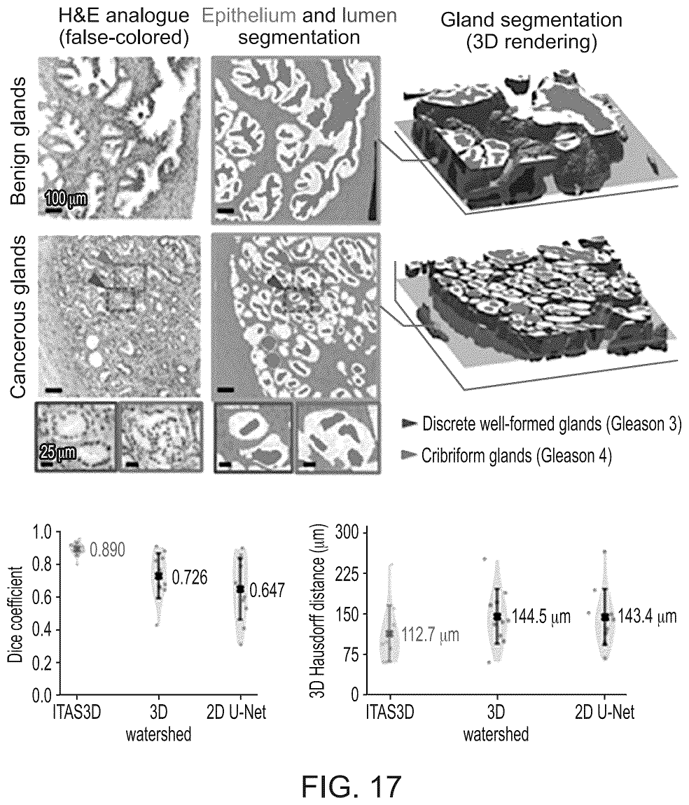

In some embodiments, each 3D imaging dataset may be composed of at least 15,000 individual images, which are stitched together to form a 3D volume. Unlike digitized glass slides, there are no suitable software programs to perform this task on 3D datasets. In some embodiments, multiple approaches to segment each tissue structure may be used including a full 3D approach (vox2vox) and in some embodiments, a 2.5D approach as described in PCT Publication No. 2022/155096, filed Jan. 10, 2022, and entitled “Apparatuses, Systems, and Methods for Generating Synthetic Image Sets,”, which is incorporated by referenced herein in its entirety. For example, FIG. 17 shows large 3D datasets containing benign glands (first row) and cancerous glands (second row). Enlarged views show small discrete well-formed glands (Gleason pattern 3, blue box) and cribriform glands (Gleason pattern 4, red box) in the cancerous region. Three-dimensional renderings of gland segmentations for a benign and cancerous region are shown on the far right (scale bar, 100 mm). For quantitative benchmarking, Dice coefficients (larger can be better) and 3DHausdorff distances (smaller can be better) are plotted for ITAS3D-based gland segmentations along with two benchmark methods (3D watershed and 2D U-net), as calculated from 10 randomly selected test regions. Violin plots are shown with mean values denoted by a center cross and SDs denoted by error bars. For the 3D Hausdorff distance, the vertical axis denotes physical distance (in microns) within the tissue. Once the dataset has been segmented, the segmented dataset can be used to train a deep learning algorithm (e.g., convolution neural network (CNN)) to recognize key features of tissue structures such as, for example, cancer cells, immune cells, and vessels automatically.

In some embodiments, in order to train the algorithm, the biopsy can be chunked or bricked into sections or pieces with overlap between adjacent pieces being about 75%. In some embodiments, overlap between adjacent sections or pieces can be in a range of about 0% to about 80% inclusive all ranges and values therebetween. In some embodiments, the sections or pieces can have a volume that is equivalent to the volume of the manually annotated ROIs. After the biopsy is divided into pieces, the algorithm can be configured to rank the sections or pieces based on likelihood the section or piece is identical to a manually annotated ROI, with better rankings being associated with a higher likelihood the section or piece is identical the manually annotated ROI.

In some embodiments, additionally and/or alternatively to using a deep learning algorithm, the algorithm may be configured to select ROIs by calculating an average nuclear intensity of each section or piece, and the section or piece with the highest average nuclear intensity may be selected. The average nuclear intensity is associated with an amount of cells in a region of tissue and because cancerous regions contain a higher number of cells than benign regions, average nuclear intensity can be used to efficiently locate cancerous regions and may use less computing power than more complex algorithms.

In some embodiments, an algorithm or method configured to execute a 3D feature-based approach can be employed to identify ROIs in the sample. After segmentation of the prostate biopsy, the algorithm selects ROIs based on which sections or pieces have the highest number of cancer cells and immune cells. Utilizing a 3D feature-based algorithm may be advantageous because selection of ROIs is based on biological features of the tissue, which enables generalizability to other tissue types beyond prostate tissue as well as minimizes susceptibility of the algorithm to latent bias. In some embodiments, the dataset can be randomly divided into 395 ROIs for training and 131 ROIs for validation. In some embodiments, the training dataset may be enhanced by data augmentation techniques such as random orientation rotations. An accurate ROI prediction can be quantified by an ROI output that has a centroid within 1 mm of the centroid of a manually annotated ROI. The model created with the training set may be evaluated using area under the curve (AUC) of a receiver operator characteristic (ROC) plot.

One or more of the algorithms approaches described above (i.e., deep learning model, average nuclear intensity, and 3D feature-based model) may be tested on 50 randomly selected manually annotated top-ranked ROIs reserved exclusively for the test set. In some embodiments, the centroid of the algorithm-generated ROI will be compared to the centroid of the manually annotated ROI. In some embodiments, the algorithm-generated ROIs may be manually assessed to determine whether they include regions of tissue including cellularity, presence of carcinoma, presence of inflammation, and/or presence of artifacts or cofounders and a qualitative description of the results may be generated. In some embodiments the qualitative description of the algorithm-generated ROIs to examine systemic bias in the algorithms and/or to better understand algorithmic errors. In some embodiments, the centroids of ROIs can be compared using a statistical test such as a T-test and/or non-parametric test. In some embodiments, a T-test with an alpha value of 0.05, power of 0.80, standard deviation of 2 mm, and a non-inferiority margin of 1 mm between centroids can be used. In some embodiments, a sample size of 35 samples can be used. In some embodiments, 50 unique biopsy samples may be used to represent a wider range of biology.

It should be understood that no claim element herein is to be construed under the provisions of 35 U.S.C. § 112(f), unless the element is expressly recited using the phrase “means for.”

While various embodiments have been described herein, textually and/or graphically, it should be understood that they have been presented by way of example only, and not limitation. Likewise, it should be understood that the specific terminology used herein is for the purpose of describing particular embodiments and/or features or components thereof and is not intended to be limiting. Various modifications, changes, enhancements, and/or variations in form and/or detail may be made without departing from the scope of the disclosure and/or without altering the function and/or advantages thereof unless expressly stated otherwise. Functionally equivalent embodiments, implementations, and/or methods, in addition to those enumerated herein, will be apparent to those skilled in the art from the foregoing descriptions and are intended to fall within the scope of the disclosure.

Where schematics, embodiments, and/or implementations described above indicate certain components arranged and/or configured in certain orientations or positions, the arrangement of components may be modified, adjusted, optimized, etc. The specific size and/or specific shape of the various components can be different from the embodiments shown and/or can be otherwise modified, while still providing the functions as described herein. More specifically, the size and shape of the various components can be specifically selected for a desired or intended usage. Thus, it should be understood that the size, shape, and/or arrangement of the embodiments and/or components thereof can be adapted for a given use unless the context explicitly states otherwise.

Although various embodiments have been described as having particular characteristics, functions, components, elements, and/or features, other embodiments are possible having any combination and/or sub-combination of the characteristics, functions, components, elements, and/or features from any of the embodiments described herein, except mutually exclusive combinations or when clearly stated otherwise.

Where methods described above indicate certain events occurring in certain order, the ordering of certain events may be modified. Additionally, certain of the events may be performed concurrently in a parallel process when possible, as well as performed sequentially as described above. While methods have been described as having particular steps and/or combinations of steps, other methods are possible having a combination of any steps from any of methods described herein, except mutually exclusive combinations and/or unless the context clearly states otherwise.

1. An apparatus, comprising:
a processor capable of being communicatively coupled to an imaging device that is configured to image a sample; and
a memory operatively coupled to the processor, the memory storing executable instructions that, when executed by the processor, cause the processor to execute operations including:
receive a low resolution image of the sample;
perform a first image processing operation on the low resolution image to determine regions of interest (ROIs) of the sample within the low resolution image;
select one or more of the determined ROIs for high resolution imaging based on the determination or an input from a user;
receive high resolution images of the selected ROIs of the sample from the imaging device;
perform a second image processing operation on the high resolution images to generate processed high resolution images; and
generate a signal indicative of the processed high resolution images.

2. The apparatus of claim 1, wherein:
the processor includes a set of processors operatively coupled to each other in parallel,
the first image processing operation includes applying bricking to the low resolution image to generate a first bricked image dataset, and
the second image processing operation includes applying bricking to the high resolution images to generate a second bricked image dataset.

3. The apparatus of claim 2, wherein:
at least one of the first bricked image dataset or the second bricked image dataset is processed in parallel to determine the regions of interest or the second bricked image is processed in parallel to generate the processed high resolution images.

4. The apparatus of claim 1, wherein the second image processing operation includes:
performing a set of image processing operations on the high resolution images to obtain optimized image data;
classifying pixels in the optimized image data into one or more classes;
segmenting the optimized image data based on features of interest;
quantifying the optimized image data; and
correlating the optimized image data to quantify structures in the optimized image data corresponding to a medical indication.

5. The apparatus of claim 4, wherein the set of image processing operations include at least one of flat fielding the set of images, stitching the set of image, registration of the set of images, autocropping the set of images, or fusion of the set of images.

6. The apparatus of claim 5, wherein the set of image processing operations further includes at least one of de-lining the high resolution images, depth correcting the high resolution images, reslicing the high resolution images, merging the high resolution images, edge correcting the high resolution images, or converting file type of the high resolution images.

7. The apparatus of claim 6, wherein the set of image processing operations further includes at least one of detecting blank spaces, fixing white-lines, fixing blank-lines, fixing black-lines, or increasing speed of virtual machine spin up.

8. A system comprising:
an imaging device configured to capture images of a sample;
a computing system communicatively coupled to the imaging device, the computing system including:
a processor communicatively coupled to the imaging;
a memory operatively coupled to the processor, the memory storing executable instructions that, when executed by the processor, cause the processor to execute operations including:
transmit a first signal to the imaging device, the first signal configured to cause the imaging device to capture a low resolution image of the sample;
receive the low resolution image from the imaging device;
process the low resolution image to determine regions of interest (ROIs) of the sample within the low resolution image;
select one or more of the determined ROIs for high resolution imaging based on the determination or an input from a user;
transmit a second signal to the imaging device, the second signal configured to cause the imaging device to capture high resolution images of the selected ROIs;
receive the high resolution images from the imaging device;
process the high resolution images to generate processed high resolution images; and
generate a signal indicative of the processed high resolution images.

9. The system of claim 8, wherein:
the imaging device includes a low resolution objective and a high resolution objective,
the causing the imaging device to capture the low resolution image includes causing the imaging device to use the low resolution objective to capture the low resolution image of the sample, and
the causing the imaging device to capture the high resolution images includes causing the imaging device to use the high resolution objective to capture the high resolution image of the ROIs.

10. The system of claim 9, wherein:
the imaging device includes an actuator,
the first signal is configured to cause the actuator to move the low resolution objective to a first predetermined position for imaging the sample, and
the second signal is configured to cause the actuator to move the high resolution objective to a second predetermined position imaging the ROIs.

11. The system of claim 10, wherein:
the second signal is also configured to move at least one of the high resolution objective or the sample to enable the high resolution objective to capture the high resolution images of the selected ROIs.

12. The system of claim 9, wherein:
the imaging device includes a detector configured to capture optical signals received from the sample, and
capturing the low resolution image includes down sampling of optical signals received from the sample.

13. The system of claim 8, wherein:
the processor includes a set of processors operatively coupled to each other in parallel,
the first image processing operation includes applying bricking to the low resolution image to generate a first bricked image dataset, and
the second image processing operation includes applying bricking to the high resolution images to generate a second bricked image dataset.

14. The system of claim 13, wherein:
at least one of the first bricked image dataset or the second bricked image dataset is processed in parallel to determine the regions of interest or the second bricked image is processed in parallel to generate the processed high resolution images.

15. The system of claim 8, wherein the second image processing operation includes:
performing a set of image processing operations on the high resolution images to obtain optimized image data;
classifying pixels in the optimized image data into one or more classes;
segmenting the optimized image data based on features of interest;
quantifying the optimized image data; and
correlating the optimized image data to quantify structures in the optimized image data corresponding to a medical indication.

16. An apparatus, comprising:
a processor capable of being communicatively coupled to an imaging device that is configured to image a sample; and
a memory operatively coupled to the processor, the memory storing executable instructions that, when executed by the processor, cause the processor to execute operations including:
receive a set of images of the sample captured by the imaging device;
perform a set of image processing operations on the set of images to obtain optimized image data;
classify pixels in the optimized image data into one or more classes;
segment the optimized image data based on features of interest;
quantify the optimized image data;
correlate the optimized image data to quantify structures in the optimized image data corresponding to a medical indication; and
generate a signal indicative of a medical indication.

17. The apparatus of claim 16, wherein the set of images include one or more depth stacks of the sample.

18. The apparatus of claim 16, wherein the performing the set of image processing operations includes generating synthetic images from the received set of images.

19. The apparatus of claim 16, wherein the optimized image data is segmented based on a segmentation criteria, the segmentation criteria based on the features of interest.

20. The apparatus of claim 16, wherein the set of image processing operations include at least one of flat fielding the set of images, stitching the set of image, registration of the set of images, autocropping the set of images, or fusion of the set of images.

21. The apparatus of claim 20, wherein the set of image processing operations further include at least one of de-lining the high resolution images, depth correcting the high resolution images, reslicing the high resolution images, merging the high resolution images, edge correcting the high resolution images, or converting file type of the high resolution images.

22. The apparatus of claim 21, wherein the set of image processing operations further include at least one of detecting blank spaces, fixing white-lines, fixing blank-lines, fixing black-lines, or increasing speed of virtual machine spin up.
